(19) United States
(12) Patent Application Publication
(10) Pub. No.: US 2024/0072379 A1
(43) Pub. Date: Feb. 29, 2024

(54) CONSTRUCTION OF BATTERY MODULE AND SYSTEMS INTERFACES FOR METAL-AIR BATTERIES

(71) Applicant: FORM ENERGY, INC., Somerville, MA (US)

(72) Inventors: Angel Ruben RIVERA, Watertown, MA (US); Kalina Chia-Shi YANG, Boston, MA (US); Katherine SPRIGGS, Boston, MA (US); Adrianna RODRIQUEZ, San Francisco, CA (US); Madeline Elliott PARKER, San Francisco, CA (US); Ryan HOWE, San Bruno, CA (US); Nicholas MCKIBBEN, Oakland, CA (US); Grant Harrison FRIESEN, Concord, CA (US); Jarrod David MILSHTEIN, Alameda, CA (US); Jaime Andres OCAMPO, Berkeley, CA (US); Jhalak Joshipura VASAVADA, San Ramon, CA (US); Alan SLEDD, Oakland, CA (US); Tuan Minh TRUONG, Newark, CA (US); Aruna MOHAN, Somerville, MA (US); Matthew DINITTO, Reading, MA (US)

(21) Appl. No.: 18/454,272

(22) Filed: Aug. 23, 2023

Related U.S. Application Data
(60) Provisional application No. 63/373,297, filed on Aug. 23, 2022.
(60) Provisional application No. 63/373,299, filed on Aug. 23, 2022.

(51) Int. Cl. H01M 50/507; H01M 10/613; H01M 10/6556; H01M 10/6566; H01M 12/08; H01M 50/264; H01M 50/287; H01M 50/636

(52) U.S. Cl. CPC H01M 50/507; H01M 10/613; H01M 10/6556; H01M 10/6566; H01M 12/08; H01M 50/264; H01M 50/287; H01M 50/636

(57) ABSTRACT

According to one aspect, a power storage system may include an enclosure, and one or more modules disposed in the enclosure. Each of the one or more modules may include a plurality of electrochemical cells electrically coupled to one another, each one of the plurality of electrochemical cells including an oxygen evolution electrode (OEE), an anode, a gas diffusion electrode (GDE), an electrolyte, and a vessel and, within the vessel, the OEE, the anode, and the GDE at least partially immersed in the electrolyte.

### CROSS-REFERENCE TO RELATED APPLICATIONS

This application claims the benefit of priority to U.S. Provisional Patent Application 63/373,297, filed Aug. 23, 2022, and to U.S. Provisional Patent Application 63/373,299, filed Aug. 23, 2022, with the entire contents of each of these applications hereby incorporated herein by reference.

### BACKGROUND

Energy storage technologies are playing an increasingly important role in electric power grids. These energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for increased availability, reliability, and/or resiliency with reduced costs in energy storage systems.

### SUMMARY

According to one aspect, a power storage system may include an enclosure, and one or more modules disposed in the enclosure, each of the one or more modules including a plurality of electrochemical cells electrically coupled to one another, each one of the plurality of electrochemical cells including an oxygen evolution electrode (OEE), an anode, a gas diffusion electrode (GDE), an electrolyte, and a vessel and, within the vessel, the OEE, the anode, and the GDE at least partially immersed in the electrolyte.

In some implementations, each of the plurality of electrochemical cells may include a printed circuit board (PCB) and a lid, the lid is supported on the vessel, and the PCB is oriented perpendicular to the lid.

In certain implementations, each of the one or more modules may include cell-to-cell busing including cables and/or busbars.

In some implementations, the plurality of electrochemical cells may be arranged in at least two columns, each one of the plurality of electrochemical cells includes a cell positive terminal and a cell negative terminal, and cell positive terminals of the plurality of electrochemical cells in a first column are electrically connected to the cell negative terminals of the plurality of electrochemical cells in a second column using two cables.

In certain implementations, each one of the plurality of electrochemical cells may include a printed circuit board (PCB), and each of the one or more modules further includes a cover positionable over the PCBs of the plurality of electrochemical cells in a respective one of the one or more modules.

In some implementations, each one of the plurality of electrochemical cells may include a printed circuit board (PCB), a lid, and a protective cover, the lid is supported on the vessel, the PCB is supported on the lid, and the protective cover is positionable on the lid to cover the PCB.

In certain implementations, each one of the plurality of electrochemical cells may further include grommets flexible for sealing the given electrochemical cell in fluid communication with an air supply duct.

In some implementations, the power storage system may further include a plenum and a gasket, wherein the gasket is disposed between the plenum and top portions of at least some of the plurality of electrochemical cells.

In certain implementations, the vessel of each one of the plurality of electrochemical cells may include a side port through which the electrolyte of the given electrochemical cell may overflow from the vessel during a charge cycle.

In some implementations, each one of the plurality of electrochemical cells may include a float valve actuatable to prevent overfilling the vessel with the electrolyte.

In certain implementations, in the module, the plurality of electrochemical cells may collectively define cooling channels therebetween and through which forced air flow is movable between the plurality of electrochemical cells.

In some implementations, each of the one or more modules may further include a pallet, end plate, and strapping, the plurality of electrochemical cells are supportable on the pallet in two columns, the end plates are releasably securable to the pallet at front and back ends of each of the two columns, and the strapping hold the two columns of the plurality of electrochemical cells and the end plates together on the pallet. As an example, the pallet may define cutouts, and the end plates are releasably securable to the pallet via the cutouts. Further, or instead, each of the one or more modules may further include tension members, each tension member connected to one of the end plates to a center of the pallet via pin joints. Still further, or instead, each of the one or more modules may further include a bracket, and the tension members are mechanically couplable to the bracket via the pin joints.

In certain implementations, each of the one or more modules may support the plurality of electrochemical cells such that forced air is movable between adjacent electrochemical cells.

In some implementations, each of the one or more modules may support the plurality of electrochemical cells such that forced air is movable over portions of the plurality of electrochemical cells towards exterior sides of the given module.

In certain implementations, the plurality of electrochemical cells may be formed in blocks within each of the one or more modules and forced air is movable between the blocks within the one or more modules.

In some implementations, the one or more modules may include a plurality of modules, each one of the plurality of modules supports the plurality of electrochemical cells in two columns, each one of the plurality of modules are spaced relative to one another within the enclosure such that forced air is movable over instances of the electrochemical cells at ends of each of the two columns of each one of the plurality of modules.

In certain implementations, the plurality of electrochemical cells may include iron-air type battery cells, zinc-air type battery cells, and/or lithium-air battery cells.

### DESCRIPTION OF THE DRAWINGS

FIG. 1 is a system block diagram of a power generation system according to various embodiments.

FIG. 2 is a system block diagram of a power generation system according to various embodiments.

FIG. 3 is a schematic representation of components of an electrochemical cell.

FIG. 4A is a perspective view of an outer portion of an electrochemical cell.

FIG. 4B is an exploded diagram of internal portions of the electrochemical cell of FIG. 4A.

FIG. 5A is a schematic representation a module including a plurality of instances of electrochemical cells, with the schematic representation shown from an overhead view looking down the height (z dimension) of the plurality of instances of the electrochemical cells, and the plurality of electrochemical cells arranged in multiple rows from front to back of the module and with depth dimensions of each of the plurality of electrodes parallel with the side-to-side dimension of the module such that the plurality of electrochemical cells form a square footprint within the module.

FIG. 5B is a schematic representation of a module including a plurality of instances of electrochemical cells, with the schematic representation shown from an overhead view looking down the height (z dimension) of the plurality of instances of the electrochemical cells, and the plurality of electrochemical cells arranged in multiple rows from side-to-side of the module and with depth dimensions of each of the plurality of electrodes perpendicular to the side-to-side dimension of the module such that the plurality of electrochemical cells form a rectangular footprint within the module.

FIG. 5C is a schematic representation of a module including a plurality of instances of the electrochemical cells, with the schematic representation shown from an overhead view looking down the height (z dimension) of the plurality of instances of the electrochemical cells, the plurality of electrochemical cells arranged as a single row and with depth dimensions of the plurality of electrochemical cells perpendicular to the side-to-side dimension of the module such that the plurality of electrochemical cells form a rectangular footprint within the module.

FIG. 5D is a schematic representation of a module including a plurality of instances of the electrochemical cells, with the schematic representation shown from an overhead view looking down the height (z dimension) of the plurality of instances of the electrochemical cells, the plurality of electrochemical cells arranged as multiple rows from side-to-side with depth dimensions of each of the plurality of electrodes perpendicular to the side-to-side dimension of the module such that the plurality of electrochemical cells form a square footprint of the module.

FIG. 6A is a perspective view of an enclosure for one or more instances of the module of FIG. 5.

FIG. 6B is a perspective view of the enclosure of FIG. 6A, shown with doors removed.

FIG. 6C is a perspective view of a lower structure of the enclosure of FIG. 6A.

FIG. 7A is schematic representation of a top-down view of an enclosure, shown with an auxiliary area within the enclosure and co-located with a plurality of instances of a module.

FIG. 7B is a schematic representation of a top-down view of a system including enclosures, each enclosure supporting a plurality of instances of modules, and each enclosure supported by a shared auxiliary area.

FIG. 7C is a schematic representation of a top-down view of a system including enclosures, each enclosure having an auxiliary area therein, and each enclosure connected to a shared auxiliary area.

FIGS. 8A-8E are schematic representations of example layouts of a plurality of instances of module within an enclosure.

FIGS. 9A-9F are schematic representations of example layouts of a plurality of instances of a module within an enclosure.

FIGS. 10A-10E are schematic representations of example layouts of a plurality of instances of a module within an enclosure.

FIG. 11 is a schematic representation of a module including multiple electrochemical cells.

FIG. 12A is a top down view of a printed circuit board (PCB) mounted perpendicular to a lid of an electrochemical cell.

FIG. 12B is a side view of the PCB mounted perpendicular to the lid of FIG. 12A.

FIG. 13A is a top-down view of a stack of electrochemical calls in which four cables connect each of the four cell positive terminals on a PCB of an electrochemical cell to the four cell negative terminals on the next electrochemical cell in the stack.

FIG. 13B is a top-down view of a stack of electrochemical cells in which busbars are used to connect each of the four cell positive terminals on a PCB of an electrochemical cell to the four cell negative terminals on the next electrochemical cell in the stack.

FIG. 13C is a schematic representation of electrical connections between groups of electrochemical cells in a module.

FIGS. 14A-14B are schematic representations of covers for PCBs of electrochemical cells.

FIG. 15 is a schematic representation of flexible over-molded grommets for air supply duct sealing of a module.

FIG. 16 is a schematic representation of a module including a gasket between the module and a plenum.

FIG. 17 is a schematic representation of electrolyte level management for electrochemical cells.

FIG. 18 is a schematic representation of a system for passive control of electrolyte volume level.

FIG. 19 is a schematic representation of thermal management components in a battery module.

FIGS. 20A-20B are schematic representations of module structures that provide protection and support to electrochemical cells of the module.

FIG. 21 is a schematic representation of a pallet of a module, the pallet including features for location and retention of electrochemical cells and end plates.

FIGS. 22-39 are computational fluid dynamic/finite element analysis simulations results associated with aspects of thermal management of modules of metal-air batteries.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments is not intended to be limiting and, instead, is intended to enable a person skilled in the art to make and use these embodiments or combinations thereof.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the disclosure provided herein. Thus, the scope of the present disclosure should not be limited to a particular embodiment, configuration or arrangement that is set forth in a particular embodiment, example, or in an embodiment in a particular figure.

Embodiments of the present disclosure may include systems, methods, and devices for electrochemical energy storage systems, such as metal-air battery systems. Systems and methods of the various embodiments may provide for construction and configuration of electrodes and/or cell components of metal-air battery systems.

Various embodiments may provide devices and/or methods for use in long-duration, and ultra-long-duration, low-cost, energy storage, including in multi-day energy storage. Herein, “long duration” and “ultra-long duration” and similar such terms, unless expressly stated otherwise, should be given their broadest possible meaning and include periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. and would include long duration energy storage (LODES) systems. Further, the terms “long duration” and “ultra-long duration”, “energy storage cells” including “electrochemical cells”, and similar such terms, unless expressly stated otherwise, should be given their broadest possible interpretation; and include electrochemical cells that may be configured to store energy over time spans of days, weeks, or seasons, such as electrochemical cells sometimes referred to as multi-day energy storage (MDS) cells. As a matter of definition, the term “duration” means the ratio of energy to power of an energy storage system. For example, a system with a rated energy of 24 MWh and a rated power of 8 MW has a duration of 3 hours; a system with a rated energy of 24 MWh and a rated power of 1 MW has a duration of 24 hours. Physically, this may be interpreted as the run-time at maximum power for the energy storage system.

In general, in an embodiment, the long duration energy storage cell can be a long duration electrochemical cell. In general, this long duration electrochemical cell can store electricity generated from an electrical generation system, when: (i) the power source or fuel for that generation is available, abundant, inexpensive, and combinations and variations of these; (ii) when the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. This electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

Various embodiments may provide devices and/or methods for use in bulk energy storage systems, such as long duration energy storage (LODES) systems (e.g., multi-day energy storage (MDS) systems), short duration energy storage (SDES) systems, etc. As an example, various embodiments may provide configurations and controls for batteries of bulk energy storage systems, such as batteries for LODES systems.

While various examples are discussed with reference to Li-ion and/or Fe-air, the discussion of Li-ion and/or Fe-air is used merely as an example and various embodiments encompass other combinations and permutations of storage technologies that may be substituted for the example solar+Li-ion+Fe-air discussions herein. For example, various metal-air storage technologies may be used as batteries in the various embodiments, such as Zinc-air, lithium-air, sodium-air, etc.

As used herein, the term “module” may refer to a string of unit electrochemical cells (e.g., a string of batteries). Multiple modules (or multiple units or electrochemical cells) may be connected together to form battery strings.

Unless otherwise expressed or made clear from the context, the recitation of any element in the singular shall be understood to be intended to encompass embodiments including one or more of such elements and the separate recitation of “one or more” is generally omitted for the sake of clarity and readability. Thus, for example, recitation of a LODES system 104 shall be understood to be inclusive of one or more LODES systems, etc.

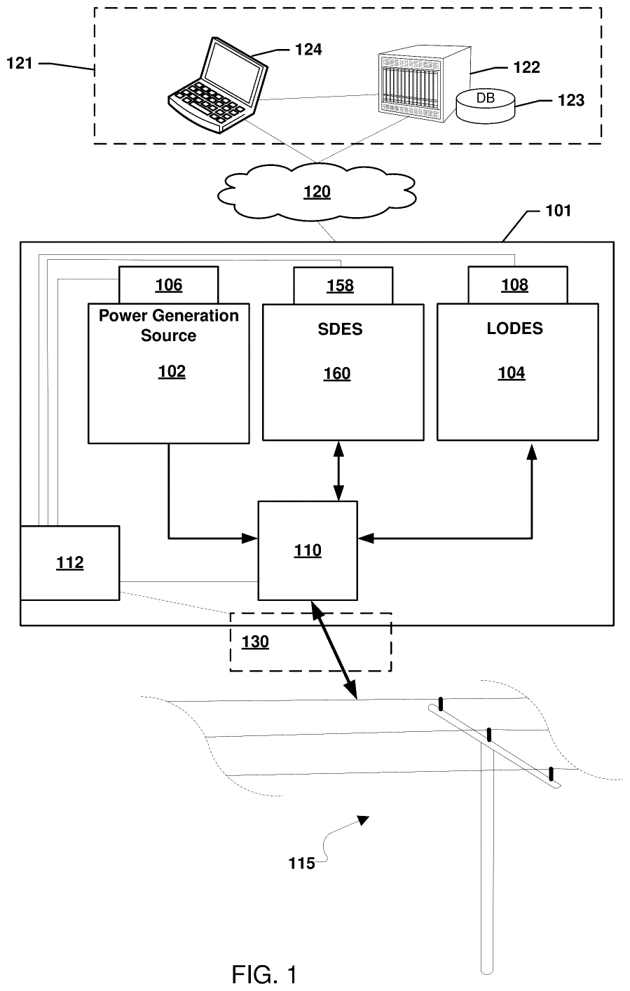

FIG. 1 is a system block diagram of a power generation system 101 according to various embodiments. The power generation system 101 may be a power plant including a power generation source 102, a LODES systems 104 (e.g., a multi-day energy storage (MDS) system), and an SDES systems 160. As examples, the power generation source 102 may include renewable power generation sources, non-renewable power generation sources, combinations of renewable and non-renewable power generation sources, etc. Examples of the power generation sources 102 include wind generators, solar generators, geothermal generators, nuclear generators, etc. The LODES system 104 may include an electrochemical cell (e.g., one or more batteries). The batteries of the LODES systems 104 may be any type of battery, such as rechargeable secondary batteries, refuellable primary batteries, combinations of primary and secondary batteries, etc. Battery chemistries may be any suitable chemistry, such as Al, AlCl₃, Fe, FeOₓ(OH)_{y}, NaₓS_{y}, SiOₓ(OH)_{y}, AlOₓ(OH)_{y}, metal-air, and/or any suitable type of battery chemistry. The SDES systems 160 may include one or more electrochemical cells (e.g., one or more batteries). The batteries of the SDES systems 160 may be any type of battery, such as rechargeable secondary batteries, refuellable primary batteries, combinations of primary and secondary batteries, etc. Battery chemistries may be any suitable chemistry, such as Li-ion, Na-ion, NiMH, Mg-ion, and/or any suitable type of battery chemistry.

In various embodiments, the operation of the power generation source 102 may be controlled by a first control system 106. The first control system 106 may include motors, pumps, fans, switches, relays, or any other type of devices that may control the generation of electricity by the power generation source 102. In various embodiments, the operation of the LODES system 104 may be controlled by a second control system 108. The second control system 108 may include motors, pumps, fans, switches, relays, or any other type of devices that may control the discharge and/or storage of electricity by the LODES system. In various embodiments, the operation of the SDES system 160 may be controlled by a third control system 158. The third control system 158 may include motors, pumps, fans, switches, relays, or any other type of devices that may control the discharge and/or storage of electricity by the SDES system 160. The first control system 106, the second control system 108, and the third control system 158 may each be connected to a plant controller 112. The plant controller 112 may monitor the overall operation of the power generation system 101 and generate and send control signals to the first control system 106, the second control system 108, and the third control system 158 to control the operations of the power generation source 102, the LODES system 104, and/or the SDES system 160.

In the power generation system 101, the power generation source 102, the LODES system 104, and the SDES system 160 may each be connected to a power control device 110. The power control device 110 may be connected to a power grid 115 or other transmission infrastructure. The power control device 110 may include switches, inverters (e.g., AC to DC inverters, DC to AC inverters, etc.), relays, power electronics, and any other type of devices that may control the flow of electricity from to/from the power generation source 102, the LODES system 104, the SDES system 160, and/or the power grid 115. Additionally, or alternatively, the power generation system 101 may include transmission facilities 130 connecting the power generation, transmission, and the power generation system 101 to the power grid 115. As an example, the transmission facilities 130 may connect between the power control device 110 and the power grid 115 such that electricity may flow between the power generation system 101 and the power grid 115. Transmission facilities 130 may include transmission lines, distribution lines, power cables, switches, relays, transformers, and any other type of devices that may support the flow of electricity between the power generation system 101 and the power grid 115. The power control device 110 and/or the transmission facilities 130 may be connected to the plant controller 112. The plant controller 112 may monitor and control the operations of the power control device 110 and/or the transmission facilities 130, such as via various control signals. As examples, the plant controller 112 may control the power control device 110 and/or the transmission facilities 130 to provide electricity from the power generation source 102 to the power grid 115, to provide electricity from the LODES system 104 to the power grid 115, to provide electricity from both the power generation source 102 and the LODES system 104 to the power grid 115, to provide electricity from the power generation source 102 to the LODES system 104, to provide electricity from the power grid 115 to the LODES system 104, to provide electricity from the SDES system 160 to the power grid 115, to provide electricity from both the power generation source 102 and the SDES system 160 to the power grid 115, to provide electricity from the power generation source 102 to the SDES system 160, to provide electricity from the power grid 115 to the SDES system 160, to provide electricity from the SDES system 160 and the LODES system 104 to the power grid 115, and/or to provide electricity from the power generation source 102, the SDES system 160, and the LODES system 104 to the power grid 115. In various embodiments, the power generation source 102 may selectively charge the LODES system 104 and/or SDES system 160 and the LODES system 104 and/or SDES system 160 may selectively discharge to the power grid 115. In this manner, energy (e.g., renewable energy, non-renewable energy, etc.) generated by the power generation source 102 may be output to the power grid 115 sometime after generation from the LODES system 104 and/or the SDES system 160.

In various embodiments, the plant controller 112 may be in communication with a network 120 (e.g., 3G network, 4G network, 5G network, core network, Internet, combinations of the same, etc.). Using the connections to the network 120, the plant controller 112 may exchange data with the network 120 as well as with devices connected to the network 120, such as a plant management system 121 or any other device connected to the network 120. The plant management system 121 may include one or more computing devices, such as a computing device 124 and a server 122. The computing device 124 and the server 122 may be connected to one another directly and/or via connections to the network 120. The various connections to the network 120 by the plant controller 112 and devices of the plant management system 121 may be wired and/or wireless connections.

In various embodiments, the computing device 124 of the plant management system 121 may provide a user interface that facilitates providing user-defined inputs to the plant management system 121 and/or to the power generation system 101, receiving indications associated with the plant management system 121 and/or with the power generation system 101, and/or otherwise controlling operation of the plant management system 121 and/or the power generation system 101.

While shown as two separate devices, 124 and 122, the functionality of the computing device 124 and server 122 described herein may be combined into a single computing device or may split among more than two devices. Additionally, or alternatively, while shown as part of the plant management system 121, the functionality of one or both the computing device 124 and the server 122 may be entirely, or partially, carried out by a remote computing device, such as a cloud-based computing system. Further, or instead, while shown as being in communication with a single instance of the power generation system 101, the plant management system 121 may be in communication with multiple instances of the power generation system 101.

While shown as being located together in FIG. 1, the power generation source 102, the LODES system 104, and the SDES system 160 may be physically separated from one another in various implementations. For example, the LODES system 104 may be downstream of a transmission constraint, such as downstream of a portion of the power grid 115, downstream from the power generation source 102 and SDES system 160, etc. In this manner, the overbuild of underutilized transmission infrastructure may be reduced, or even avoided, by situating the LODES system 104 downstream of a transmission constraint, charging the LODES system 104 at times of available capacity and discharging the LODES system 104 at times of transmission shortage. The LODES system 104 may also, or instead, arbitrate electricity according to prevailing market prices to reduce the final cost of electricity to consumers.

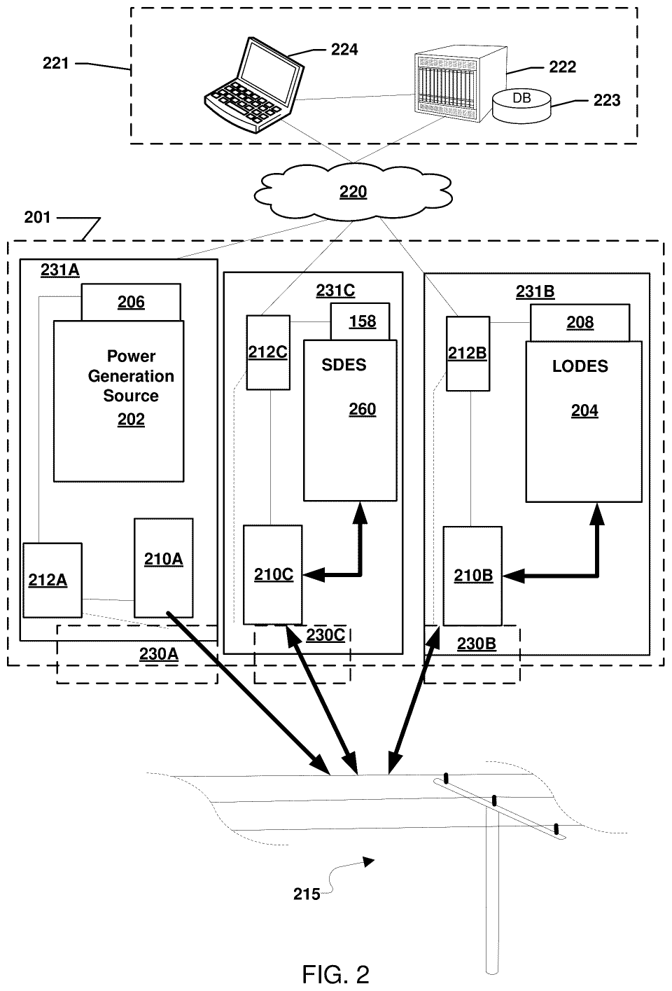

FIG. 2 is a system block diagram of a power generation system 201 in which various elements of the power generation system 201 may be physically separated from one another according to various embodiments. For the sake of clear and efficient description, elements in FIG. 2 with numbers having the same last two digits as in FIG. 1 shall be understood to be analogous to or interchangeable with one another, unless otherwise specified or made clear from the context, and, therefore, are not described separately from one another, except to note differences and/or to emphasize certain features. For example, the power generation system 101 (FIG. 1) shall be understood to be analogous to and/or interchangeable with the power generation system 201, unless a contrary intent is expressed or made clear from the context.

As an example, the power generation system 201 may include a power generation source 202 and one or more bulk energy storage systems, such as a LODES system 204 and/or an SDES system 260. The power generation source 202, the LODES system 204, and/or the SDES system 160 may be separated in the power plants 231A, 231B, 231C, respectively. While the power plants 231A, 231B, 231C may be separated from one another, the power generation system 201 and a plant management system 121 may operate as described above with reference to operation of the power generation system 101 and the plant management system 121 (FIG. 1). While the power plants 231A, 231B, and 231C may be co-located or may be geographically separated from one another. The power plants 231A, 231B, and 231C may connect to the power grid 215 at different places. For example, the power plant 231A may be connected to the power grid 215 upstream of where the power plant 231B is connected.

In some implementations, the power plant 231A associated with the power generation source 202 may include dedicated equipment for the control of the power plant 231A and/or for transition of electricity to/from the power plant 231A. For example, the power plant 231A may include a plant controller 212A and a power controller 110A and/or a transmission facility 230A. The power controller 210A and/or the transmission facility 230 may be connected in electrical communication with the plant controller 112A. The plant controller 212A may, for example, monitor and control the operations of the power controller 210A and/or the transmission facility 230A, such as via various control signals. As examples, the plant controller 212A may control the power controller 210A and/or transmission facility 230A to provide electricity from the power generation sources 202 to the power grid 215, etc.

Additionally, or alternatively, the power plant 231B associated with the LODES system 204 may include dedicated equipment for the control of the power plant 231B and/or for transmission of electricity to/from the power plant 231B. For example, the power plant 231B associated with the LODES system 204 may include a plant controller 112B, a power controller 210B, and/or a transmission facility 230B. The power controller 210B and/or the transmission facility 230B may be connected to the plant controller 212B. The plant controller 212B may monitor and control the operations of the power controller 210B and/or of the transmission facility 230B, such as via various control signals. As an example, the plant controller 212B may control the power controller 210B and/or the transmission facility 230B to provide electricity from the LODES system 204 to the power grid 215 and/or to provide electricity from the power grid 215 to the LODES system 204, etc.

Still further, or instead, the power plant 231C associated with the SDES system 260 may include dedicated equipment for the control of the power plant 231C and/or for transmission of electricity to/from the power plant 231C. For example, the power plant 231C associated with the SDES system 260 may include a plant controller 212C and a power controller 210C and/or a transmission facility 230C. The power controller 210C and/or the transmission facility 230C may be connected to the plant controller 212C. The plant controller 212C may monitor and control the operations of the power controller 210C and/or transmission facility 230C, such as via various control signals. As examples, the plant controller 212C may monitor and control the operations of the power controller 210C and/or transmission facility 230C, such as via various control signals. As examples, the plant controller 212 may control the power controller 210C and/or the transmission facility 230C to provide electricity from the SDES system 260 to the power grid 215 and/or to provide electricity from the power grid 215 to the SDES system 260, etc.

In various embodiments, the plant controllers 212A, 212B, 212C may each be in communication with each other and/or with a network 220. Using the connections to the network 220, the plant controllers 212A, 212B, 212C may exchange data with the network 220 as well as with one or more devices connected to the network 220, such as a plant management system 221, each other, or any other device connected to the network 220. In various embodiments, the operation of the plant controllers 212A, 212B, 212C may be monitored by the plant management system 221 and the operation of the plant controllers 212A, 212B, 212C—and, thus, operation of the power generation system 201, may be controlled by the plant management system 221.

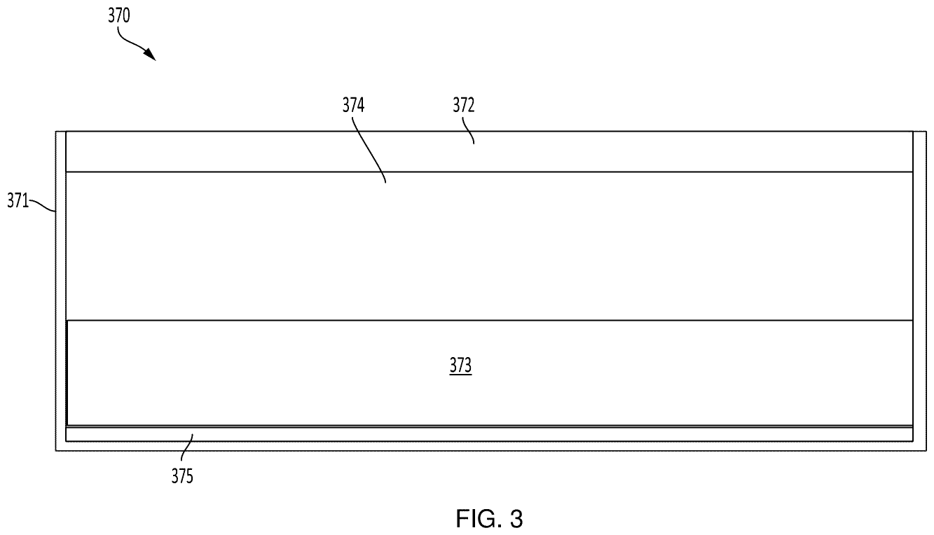

FIG. 3 is a schematic view of a battery 370 that may be used in the one or more LODES systems described herein (e.g., the LODES system 204 in FIG. 1 and/or the LODES system 204 in FIG. 2). The battery 370 may include a vessel 371, a gas diffusion electrode (GDE) 372, an anode 373, an electrolyte 374, and a current collector 375. The GDE 372, the anode 373, the electrolyte 374, and the current collector 375 may each be disposed in the vessel 371. The anode 373 may include a metal electrode (e.g., an iron electrode, a lithium electrode, a zinc electrode, or other type of suitable metal). The electrolyte 374 may separate the GDE 372 from the anode 373. Additionally, specific examples of batteries, such as batteries similar to battery 370, that may be used in bulk energy storage systems, such as in LODES systems of the present disclosure are described in U.S. Pat. App. Pub. 2021/0028457, the entire contents of which are incorporated herein by reference. As examples, the battery 370 may be a metal-air type battery, such as an iron-air battery, a lithium-air battery, a zinc-air battery, etc. While various examples are discussed with reference to metal-air batteries, other type batteries may be additionally, or alternatively, used in the various examples provided herein unless otherwise specified or made clear from the context. The battery 370 may be a single cell or unit, and multiple instances of the battery 370—namely, multiple units or cells—may be connected together to form a module. Multiple modules may be connected to one another to form a battery string.

In various embodiments, the anode 373 may be solid and the electrolyte may be excluded from the anode. In various embodiments the anode 373 may be porous and the electrolyte 374 may be interspersed geometrically with the anode 373, creating a greater interfacial surface area for reaction. Further, or instead, the air electrode 203 may be porous and the electrolyte 374 may be interspersed geometrically with the anode 373, creating a greater interfacial surface area for reaction. Still further, or instead, the GDE 372 may be at an interface of the electrolyte 374 and a gaseous headspace (not shown in FIG. 3). The gaseous headspace may, for example, be sealed in a housing. Additionally, or alternatively, the housing may be unsealed and the gaseous headspace may be an open system which can freely exchange mass with the environment.

The anode 373 may be formed from a metal or metal alloy, such as lithium (Li), sodium (Na), potassium (K), magnesium (Mg), calcium (Ca), silicon (Si), aluminum (Al), zinc (Zn), or iron (Fe); or alloys substantially comprised of one or more of the forgoing metallic elements, such as an aluminum alloy or iron alloy (e.g., FeAl, FeZn, FeMg, etc.) that can undergo an oxidation reaction for discharge. As such, the anode 373 may be referred to as a metal electrode herein.

In certain embodiments, the battery 370 may be rechargeable and the anode 373 may undergo a reduction reaction when the battery 370 is charged. The anode 373 may be a solid, including a dense or porous solid, or a mesh or foam, or a particle or collection of particles, or may be a slurry, ink, suspension, or paste deposited within the housing. In various embodiments, composition of the anode 373 may be selected such that the anode 373 and the electrolyte 374 do not mix together to any substantial extent, allowing for only small amounts of solubility that do not impact performance of the battery 370. For example, the anode 373 may be a metal electrode that may be a bulk solid. Further, or instead, the anode 373 may include a collection of particles, such as small or bulky particles, within a suspension, and the collection of particles may not be buoyant enough to escape the suspension into the electrolyte 374. Additionally, or alternatively, the anode 373 may include particles that are not buoyant in the electrolyte 374.

The GDE 372 may support the reaction with oxygen. As an example, the GDE 372 may be a solid and may sit at the interface of a gas headspace and the electrolyte 374. During the discharge process, the GDE 372 may support the reduction of oxygen from the gaseous headspace, in a reaction known as the Oxygen Reduction Reaction (ORR). In certain embodiments, the battery 370 may be rechargeable and the reverse reaction may occur—namely, the reaction in which the GDE supports the evolution of oxygen from the battery, in a reaction known as Oxygen Evolution Reaction (OER). The OER and ORR reactions are commonly known to those skilled in the art.

In various embodiments, the electrolyte 374 may be a liquid electrolyte. For example, the electrolyte 374 may be an aqueous solution, a non-aqueous solution, or a combination thereof. In various embodiments, the electrolyte 374 may be an aqueous solution which may be acidic (low-pH), neutral (intermediate pH), or basic (high pH; also called alkaline or caustic). In certain embodiments, the electrolyte 374 may comprise an electropositive element, such as Li, K, Na, or combinations thereof. In some embodiments, the liquid electrolyte may be basic, namely with a pH greater than 7. In some embodiments the pH of the electrolyte may be greater than 10 (e.g., greater than 12). For example, the electrolyte 374 may include a 6M (mol/liter) concentration of potassium hydroxide (KOH). In certain embodiments, the electrolyte 374 may include a combination of ingredients such as 5.5M potassium hydroxide (KOH) and 0.5M lithium hydroxide (LiOH). In certain embodiments, the electrolyte 374 may comprise a 6M (mol/liter) concentration of sodium hydroxide (NaOH). In certain embodiments, the electrolyte 374 may comprise a 5M (mol/liter) concentration of sodium hydroxide (NaOH) and 1M potassium hydroxide (KOH).

In certain embodiments, the battery 370 (e.g., metal-air battery) may discharge by reducing oxygen (O₂) typically sourced from air. This may achieved by a triple-phase contact between gaseous oxygen, an electronically active conductor which supplies the electrons for the reduction reaction, and the electrolyte 374 which contains the product of the reduction step. For example, in certain embodiments involving an aqueous alkaline electrolyte, oxygen from air may be reduced to form hydroxide ions through the half-reaction O₂+2H₂O+4e⁻→4OH⁻. Thus, oxygen delivery to metal-air cells may include gas handling and maintenance of triple-phase points. In certain embodiments, sometimes referred to as “normal air-breathing” configurations, the GDE 372 may be positioned at the gas-liquid interface to promote and maintain triple-phase boundaries. The GDE 372 may be positioned vertically or horizontally, or at any intermediate angle with respect to gravity, and maintain a “normal air-breathing” configuration. In these “normal air-breathing” configurations, the gas phase is at atmospheric pressure—that is, gas phase is unpressurized beyond the action of gravity.

The battery 370 in FIG. 3 is merely an example of one electrochemical cell according to various embodiments and is not intended to be limiting. Other configurations, such as electrochemical cells with different types of vessels and/or without the vessel 371, electrochemical cells with different types of air electrodes and/or without the GDE 372, electrochemical cells with different types of current collectors and/or without the current collector 375, electrochemical cells with different types of anodes and/or without the anode 373, and/or electrochemical cells with different types of electrolytes and/or electrochemical cells without the electrolyte 374 may be substituted for the example configuration of the battery 370, and other arrangements are in accordance with the various embodiments.

In various embodiments, the vessel 371 may be made from a polymer such as polyethylene, acrylonitrile butadiene styrene (ABS), high-density polyethylene (HDPE), ultra-high molecular weight polyethylene (UHMW), polypropylene, and/or other polymers. In certain embodiments, the vessel 371 and/or housing for the battery 370 may be made from a metal such as nickel, steel, anodized aluminum, nickel coated steel, nickel coated aluminum or other metal.

In various embodiments, a battery (e.g., the battery 370) may include three electrodes—an anode (e.g., the anode 373) and a dual cathode (e.g., GDE 372 including two parts, such as a first cathode, and a second cathode). The electrodes may have finite useful lifetimes, and may be mechanically replaceable. For example, the anode may be replaced seasonally. The first cathode of the dual cathode may be divided into two portions, a first portion having a hydrophilic surface and a second portion having a hydrophobic surface. For example, the hydrophobic surface may have a polytetrafluorethylene (PTFE) (e.g., Teflon®) hydrophobic surface.

For example, the second portion having the hydrophobic surface may include a microporous layer of polytetrafluorethylene (PTFE) and high surface area carbon while the first portion having the hydrophilic surface may include carbon fiber partially coated with PTFE. As another example, the second portion may include a microporous layer of PTFE and carbon black and the first portion may include PTFE of approximately 33% by weight. As a further example, the second portion may include a microporous layer of 23% by weight PTFE and 77% by weight carbon black and the first portion may include a low loading microporous layer. The anode may be an iron (Fe) electrode or an iron-alloy (Fe-alloy) electrode (e.g., FeAl, FeZn, FeMg, etc.). The second cathode of the dual cathode may include a hydrophilic surface. The second cathode of the dual cathode may include a metal substrate, such as carbon (C), titanium (Ti), steel, etc., coated with nickel (Ni). Electrolyte (e.g., electrolyte 140) may be disposed between the three electrodes. The electrolyte may be infiltrated into one or more of the three electrodes.

Battery systems may include a number of cells connected in series and/or parallel in a shared electrolyte bath and contained in a housing.

Referring now to FIGS. 1-4B, FIG. 4A an electrochemical cell 400 may include at least one battery, such as at least one instance of the battery 200, in accordance with various embodiments. In some implementations, the electrochemical cell 400 may include a vessel 401 (e.g., such as the vessel 371), in which an air electrode (e.g., a cathode), such as the GDE 372, a negative electrode (e.g., an anode), such as the anode 373, and an electrolyte, such as the electrolyte 374, are disposed. The electrolyte, such as the electrolyte 374, may rise to a given level within the vessel 401 and a headspace between the top of the vessel 401 and electrolyte level may be formed in the electrochemical cell 400. The vessel 401 may have a height (e.g., a z dimension), a width (e.g., a y dimension), and a depth (e.g., a x dimension). In one example configuration, the height may be greater than the width and depth and the width may be greater than the depth such that the vessel 401 is a generally rectangular cuboid. The vessel 401 may include one or more various connections, such as electrical connections, electrolyte connections, gas connections (e.g., air connections), vents, etc. Via the connections, two or more electrochemical cells (e.g., two or more instances of the the electrochemical cell 400) may be connected together, such as in series and/or in parallel, to form a module.

In a module formed of a plurality of instances of the electrochemical cell 400, each instance of the electrochemical cell 400 may be a self-contained unit supporting its own respective air electrode (e.g., the GDE 372), anode electrode (e.g., the anode 373), and electrolyte (e.g., the electrolyte 374). The module structure may support the vessel 401 of the electrochemical cell 400 disposed within the given module.

The vessel 401 may have disposed within it one or more instances of the anode assembly 402 (e.g., one or more instances of the anode 373), one or more instances of a cathode (e.g., the air electrode 203), and an electrolyte (e.g., the electrolyte 374). As an example, each instance of the cathode assembly may include a respective instance of an Oxygen Evolution Electrode (OEE) 403 and a gas diffusion electrode (GDE) 404. A battery including at least one instance of the OEE 403 and at least one instance of the GDE 404 may be referred to as a multi-cathode battery cell.

The OEE 403 may be disposed within the vessel 401, between the anode assembly 402 and the GDE 404. In some implementations, the electrochemical cell 400 may include an electronics structure 450, which may include a printed circuit board assembly (PCBA), circuitry housing, etc., as may be useful for supporting various electronic devices (e.g., controllers, sensors, switches, wiring buses, etc.) that may control and/or manage one or more operations of the electrochemical cell 400. The electrochemical cell 400 may additionally, or alternatively, include a lid 455 and an electrode holder 454 on opposite sides along a length dimension of the vessel 401. Straps 453 may secure the lid 455 and the electrode holder 454 to the vessel 401. The electronics structure 450 may be supported on the lid 455 in some configurations.

In general, the OEE 403, the anode assembly 402, and the GDE 404 may each be disposed in an electrolyte 497 within the volume of the vessel 401 of the electrochemical cell 400. As discussed herein, the GDE 404 may include a two part electrode with two faces sealed on three-sides to form a two-faced pocket construction defining a central air passage between the two faces. As compared to other configurations, the amount of inactive material used in construction of the GDE 404 (e.g. flowfield, epoxy “trough” or frame) may be reduced by making a 2-sided GDE (air in the middle with active faces on either side).

With reference to FIGS. 1-4B and 5A, a module 501 is shown from an overhead view looking down the height (e.g., z dimension) of a plurality of instances of the electrochemical cell 400. The module 501 may be a generally square configuration with the front, back, and sides of the module 501 about the same lengths. In the module 501, the plurality of instances of the electrochemical cell 400 may be arranged in two rows such that the respective width dimensions of the plurality of instances of the electrochemical cell are parallel to the sides of the module 501 and the respective depths of the vessel 401 run parallel to the front and back of the module 501. In the configuration of the module 501, the combined width of the two rows of the plurality of instances of the electrochemical cell 400, along with any spacing between the two rows and the front and the back of the module, may generally govern the length of each side of the module 501. The number of instances of the electrochemical cell 400 in each row and the depth dimension of each instance of the vessel 401, along with the spacing between the instances of the vessel 401 in each row and the spacing of the respective rows from the sides of the module 501, may generally govern the length from the front to the back of the module 501. As described in greater detail below, other arrangements of a plurality of instances of the electrochemical cells 400 are additionally, or alternatively, possible to form modules with other footprints.

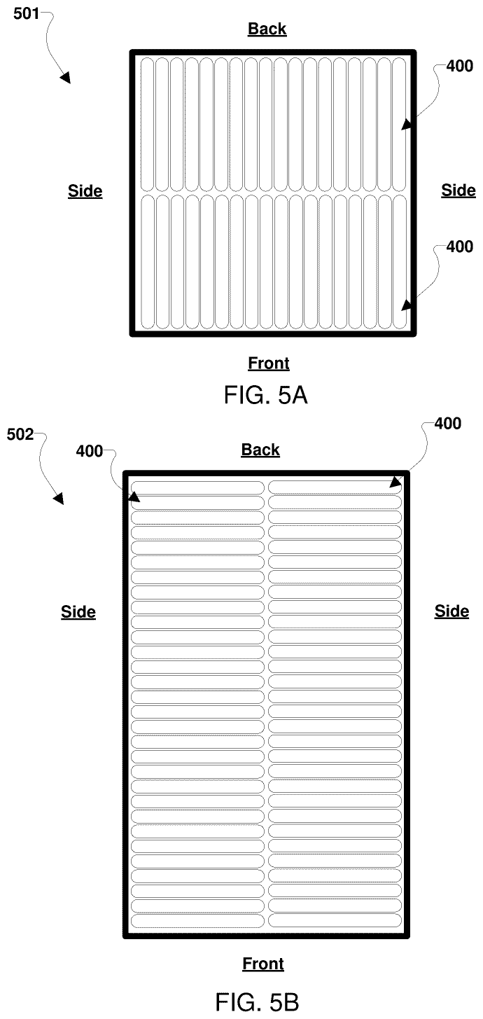

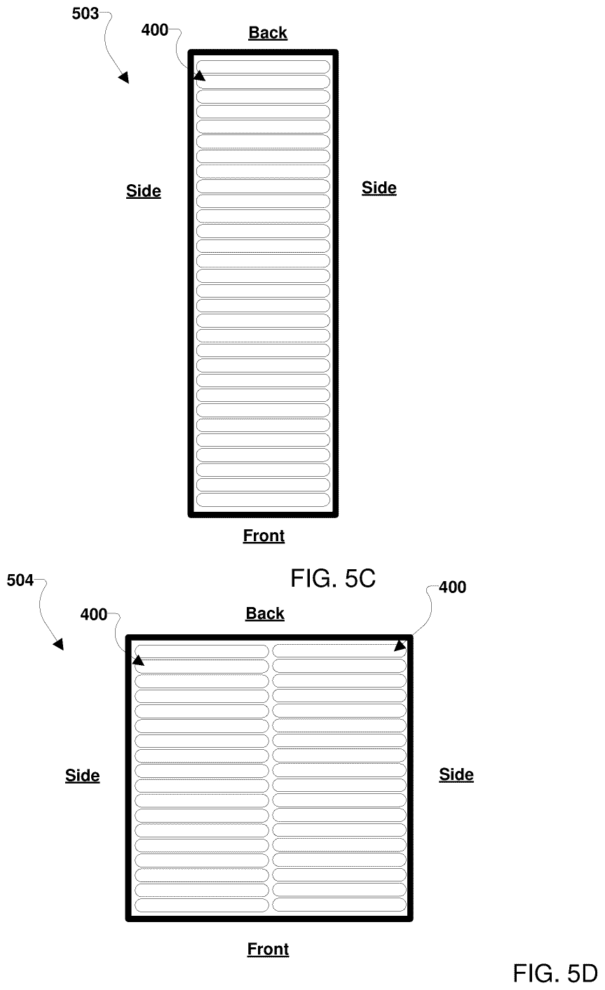

As another example, while the module 501 has been described as having a particular arrangement of electrochemical cells to form a particular footprint, it shall be appreciated that other arrangements of electrochemical cells are additionally or alternatively possible to form modules. As an example, referring now to FIG. 5B, a module 502 configuration may include multiple instances of the electrochemical cell 400 in accordance with various embodiments. The module 502 configuration may be a generally rectangular configuration with the sides of the module 502 longer than the back and front of the module 502. In the module 502, two rows of instances of the electrochemical cell 400 may be arranged such that the widths of the plurality of instances of the electrochemical cell 400 are parallel to the front and back of the module 502 and the depths of the plurality of instances of the electrochemical cell 400 are parallel to the sides of the module 502. In the configuration of the module 502, the widths of two instances of the electrochemical cell 400 may generally govern the length of the front and back of the module 502 along with any spacing between the rows of instances of the electrochemical cell 400 and spacing of the respective rows and the sides of the module 502. The number of instances of the electrochemical cell 400 in each row and the depth of the plurality of instances of the electrochemical cells 400 may generally govern the length of the sides of the module 502 along with the spacing between the plurality of instances of the electrochemical cells 400 in each row and the spacing of the respective rows and the front and back of the module 502.

As another example, referring now to FIG. 5C, a module 503 configuration may include multiple instances of the electrochemical cell 400 in accordance with various embodiments. The module 503 may be a generally rectangular configuration with the sides of the module 503 longer than the back and front of the module 503. In the module 503, a single row of instances of the electrochemical cell 400 may be arranged such that the widths of the instances of the electrochemical cell 400 are parallel to the front and back of the module 503 and the depths of the instances of the electrochemical cell 400 are parallel to the sides of the module 502. In the module 503, the widths of the single row of instances of the electrochemical cell 400 may generally govern the length of the front and back of the module 503 along with any spacing between the sides of the module 503. The number instances of the electrochemical cell 400 in the row and the depth of the instances of the electrochemical cell 400 may generally govern the length of the sides of the module 503 along with the spacing between the instances of the electrochemical cell 400 in the row and the spacing between the front and back of the module 503.

As yet another example, referring now to FIG. 5D a module 504 may be generally square with the front, back, and sides of the module 504 about the same lengths. In the module 504, two rows of instances of the electrochemical cell 400 may be arranged such that the widths of the instances of the electrochemical cell 400 are parallel to the front and back of the module 504 and the depths of the instances of the electrochemical cell 400 are parallel to the sides of the module 504. In the module 504, the widths of the two instances of the electrochemical cell 400 may generally govern the length of the front and back of the module 504 along with any spacing between the rows of instances of the electrochemical cell 400 and spacing of the respective rows and the sides of the module 504. The number of instances of the electrochemical cell 400 in each row and the depths of the instances of the electrochemical cell 400 may generally govern the length of the sides of the module 504 along with the spacing between the instances of the electrochemical cell 400 in each row and the spacing of the respective rows and the front and back of the module 504.

Other configurations, of a plurality of instances of the electrochemical cell are additionally or alternatively possible, such as modules with more or fewer rows, modules with non-linear arrangements of electrochemical cells, modules with more or fewer electrochemical cells, etc., may be substituted for the example configuration of the modules described above and other configurations are in accordance with the various embodiments.

In various embodiments, battery modules having strings of electrochemical cells therein may be enclosed in an enclosure. The enclosure may house one or more instances of a module, with each instance of a module having strings of electrochemical cells therein. In description that follows, enclosures are described with respect to a plurality of instances of the module 501 (FIG. 5A). It shall be appreciated, however, that this is for the sake of clear and efficient description. That is, unless otherwise indicated or made clear from the context, any reference the module 501 (FIG. 5A) in enclosures shall be understood to apply equally to any other arrangement of electrochemical cells in a module and, thus, shall be understood to apply equally to the module 502 (FIG. 5B), to the module 503 (FIG. 5C), and to the module 504 (FIG. 5D).

Instances of the module 501 deployed in the field may need protection from the elements, such as: wind, dust, snow, rain, seismic activity, etc. The instances of the module 501 may also, or instead, need to be secured to the ground to reduce the likelihood of movement in the event of heavy winds and/or seismic activity. Personnel also need to have protections from high voltage, caustic fluids, and any other hazardous conditions associated with the operation of a battery system. There are several auxiliary systems that may also be required to support operating the battery energy storage system, including secondary containment, thermal management, hydrogen management, gas diffusion electrode (GDE) support, air supply, electrolyte/water management, etc.

Referring now to FIGS. 1-5A and 6A-6C, one or more instances of the module 501 may be positioned in the enclosure 605. As an example, the enclosure 605 may include a lower structure 602, walls 603, 604, 606, 607, a roof 611, and doors 612, 614.

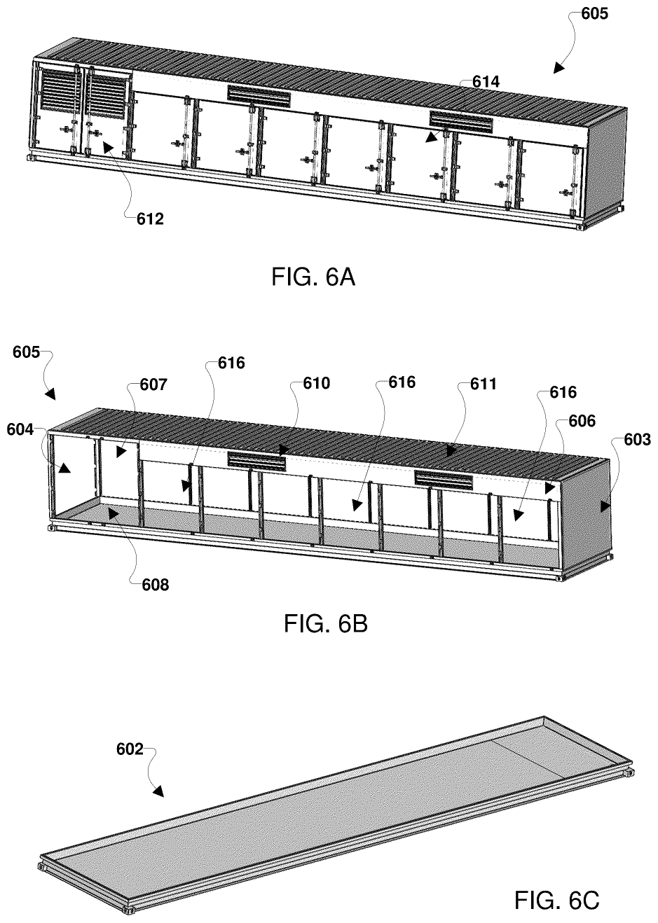

In some implementations, the lower structure 602 may support the entire weight of the plurality of instances of the module 501 for transport and installation. A secondary containment may be fabricated into the lower structure 602, for example to handle both the potential for a spill and fire water if it is incorporated in the design. Lifting points may be provided in the lower structure 602 such that the lower structure 602 may be lifted either by the corners or have additional pick points incorporated along its length. The base of the lower structure 602 may include attachment points to facilitate securing the one or more instances of the module 501 to the enclosure 605, for example to support shipping, seismic event dampening, etc. To facilitate protecting the one or more instances of the module 501 as installed and/or during transport, the enclosure 605 may include doors 612 and 614. Additionally, other doors and/or hatches may be installed along other walls and/or the roof of the enclosure 605. The configuration of the enclosure 605 shown in FIGS. 6A-6C shows a configuration for at least seven modules, but it shall be appreciated that more or fewer modules may be present in the enclosure 605 depending on enclosure size and/or configuration. Still further, or instead, the enclosure 605 may include mounting points provided to attach to a variety of field installation structures, such as grade beams, piles, helical piers, foundations, etc., upon deployment in the field.

In some embodiments, the enclosure 605 may include an auxiliary area 608. As an example, the auxiliary area 608 may be at one end of the enclosure 605. Further, or instead, auxiliary equipment may be mounted in the auxiliary area to support operation of the one or more instances of the modules 501. Auxiliary equipment may include, pumps, blowers, controllers, switches, connections, tubing, ducting, heaters, chillers, filters, reservoirs, tanks, electronics, or any other type of equipment that may support the operation of the one or more instances of the module 501 within the enclosure 605. The support subsystems may be housed in the auxiliary area 608 and connected to the one or more instances of the module 501. The support subsystems may include GDE air systems, thermal management systems, heating systems, hydrogen management systems, water and/or electrolyte management systems, power electronics systems, controls electronics systems, communication systems, telemetry sensors and equipment, and/or disconnects from plant level services, as well as any other type of subsystems. Further, or instead, the floor of the enclosure 605 may define perforations to allow for stub ups of electrical, water, or any other desired connection to be made upon installation in the field. The perforation may maintain the secondary containment requirements of the lower structure 602.

The walls 603, 604, 606, and 607 may be attached to the lower structure 602 and, in some instances, may support snow loads taken up by the roof 611 and/or may handle wind loads upon the enclosure 605. The structural shell formed by the walls 603, 604, 506, and 607 attached to the lower structure 602 may further, or instead, may provide mounting for auxiliary subsystems that need to be run throughout the enclosure 605 to support operation of the one or more instances of the module 501. While the walls 603, 604, 606, and 607 and the roof 611 may each be metal in some instances, it shall be appreciated that all or portions of the walls 603, 604, 606, and 607 and/or the roof 611 may be formed from other materials, such as fabric, cloth, etc.

In various implementations, the enclosure 605 may be formed into different areas, such as the auxiliary area 608 and module bays 616. In various embodiments, the auxiliary area 608 may be covered by the door 612 on one or both long sides of the enclosure 605, and the module bays 616 may be covered by doors 614 on one or both long sides of the enclosure 605. The doors 612 and/or 614 may facilitate access to the auxiliary equipment and/or to one or more instances of the module 501 for maintenance, repair, and/or replacement. In some embodiments, perforations 610 may be defined by the walls 606 and/or by the roof 611 to facilitate exchanging air from ambient to the enclosure 605 and vice versa. The perforations 610 may include, for example, filter grates. Further, or instead, the enclosure 605 may maintain low dust intrusion and/or protect against driven rain.

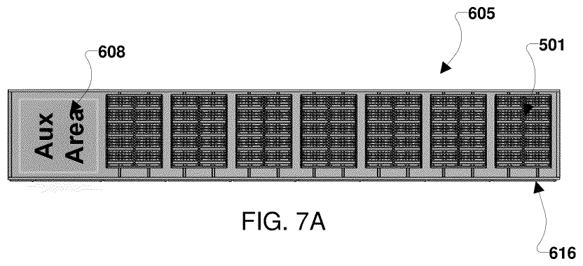

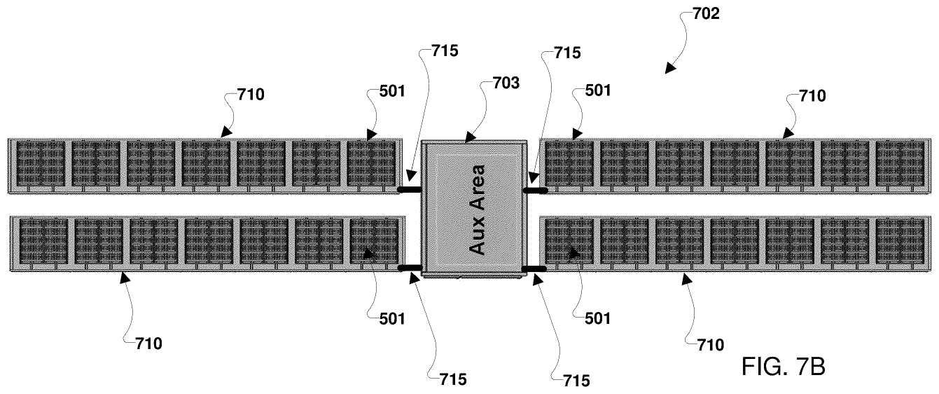

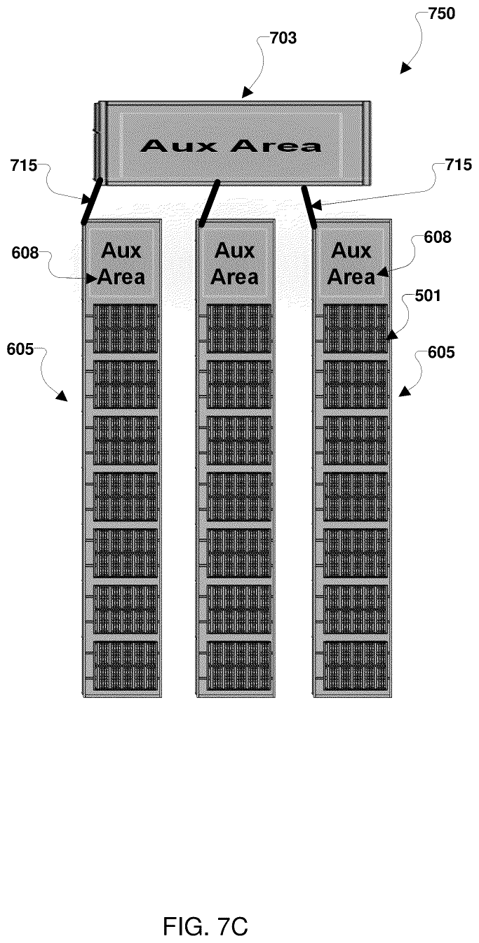

Referring now to FIG. 7A, an auxiliary area 608 may be within the enclosure 605 and co-located with the one or more instances of the module 501 within the module bays 616. While the enclosure 605 is shown as including seven instances of the module 501, it shall be appreciated that more or fewer instances of the module 501 may be disposed in the enclosure 605, as may be useful for accommodating different end-use cases.

Referring now to FIG. 7B, a system 702 may include a plurality of instances of an enclosure 710 supporting a plurality of instances of the module 501. A shared auxiliary area 703 may support the plurality of instances of the enclosure 710. The shared auxiliary area 703 may be connected to each of the plurality of instances of the module 501 by one or more connections 715 and the shared auxiliary area 703 may feed the subsystem services, such as those of GDE air systems, thermal management systems, hydrogen management systems, water and/or electrolyte management systems, power electronics systems, controls electronics systems, telemetry sensors and equipment, and/or disconnects from plant level services, as well as any other type subsystems, to the plurality of instances of the enclosure 710 and the plurality of instances of the module 501 therein. While four instances of the enclosure 710 are shown in FIG. 7B, more or fewer instances of the enclosure 710 may be connected to the shared auxiliary area 703 and the shared auxiliary area 703 may be sized according to the number of enclosures to support and number of modules within the enclosures.

Referring now to FIG. 7C, a system 750 may include the shared auxiliary area 703 enclosure is connected to a plurality of instances of the enclosure 605, with each instance of the enclosure 605 having the auxiliary area 608 therein. In this manner, some auxiliary system functions may be in whole, or in part, offloaded to the shared auxiliary area 705 and some auxiliary system functions may in whole, or in part, be at the level of the enclosure 605.

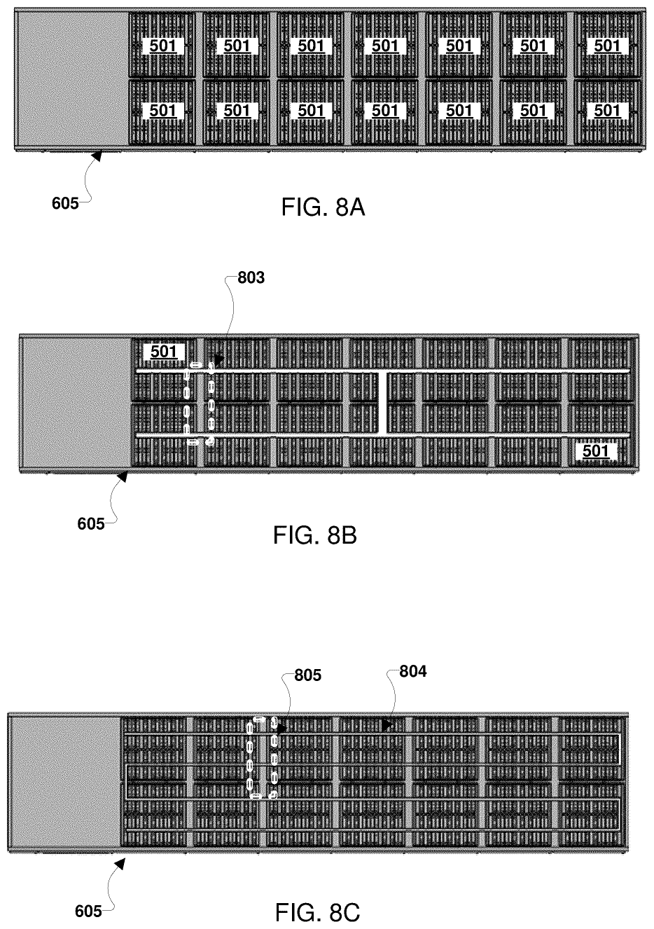

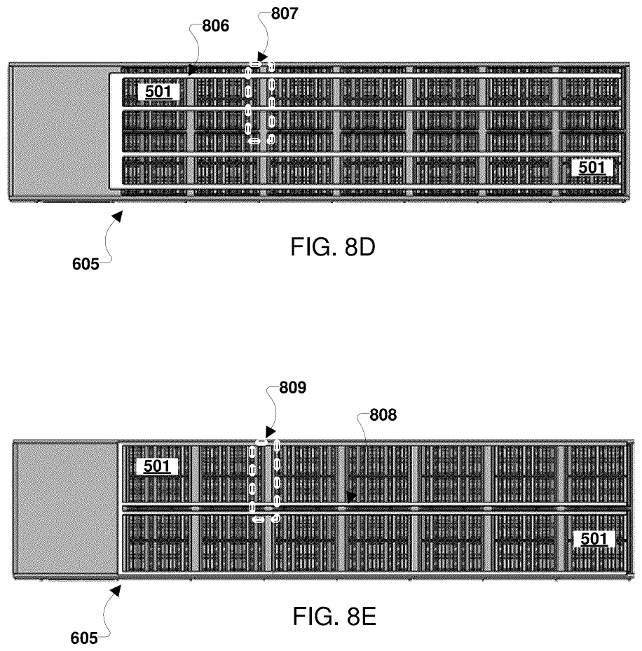

FIGS. 8A-8E are schematic representations of example layouts of a plurality of instances of the module 501 within the enclosure 605. In each of the layouts shown in FIGS. 8A-8E, two instances of the module 501 are arranged front to back within a given bay of the enclosure 605. In these layouts, electrical routing may be provided, and all hookups may be on the enclosure 605 short end. Further, space may be provided within the enclosure 605 to facilitate removal of an instance of the module 501. Further or instead, width of an electrode of electrochemical cells of the module 501 may be tied to the smallest dimension of the enclosure 605. Still further, or instead, thermal spacing of the electrochemical cells of the module 501 and/or of a plurality of instances of the module 501 relative to one another may be tied to the smallest dimension of the enclosure 605. Certain layouts may include connection and/or disconnection of a back portion of one or more instances of the module in each bay of the enclosure 605. Still further, or instead, the layout may facilitate some activities of personnel being performed within the enclosure 605.

Referring now to FIG. 8B, a thermal management ducting/plumbing system 803 may be within the enclosure 605 to facilitate installing and/or removing one or more instances of the module 501. Referring now to FIG. 8C, an electrical system connection configuration 804 and electrical connections 805 may be within the enclosure 605 to facilitate installing and/or removing one or more instances of the module 501. Referring now to FIG. 8D, GDE air system 806 and air connections 807 may be within the enclosure 605 to facilitate installing and/or removing one or more instances of the module 501. Referring now to FIG. 8E, a water and/or electrolyte system 808 and fluid connections 809 may be within the enclosure 605 to facilitate installing and/or removing one or more instances of the module 501.

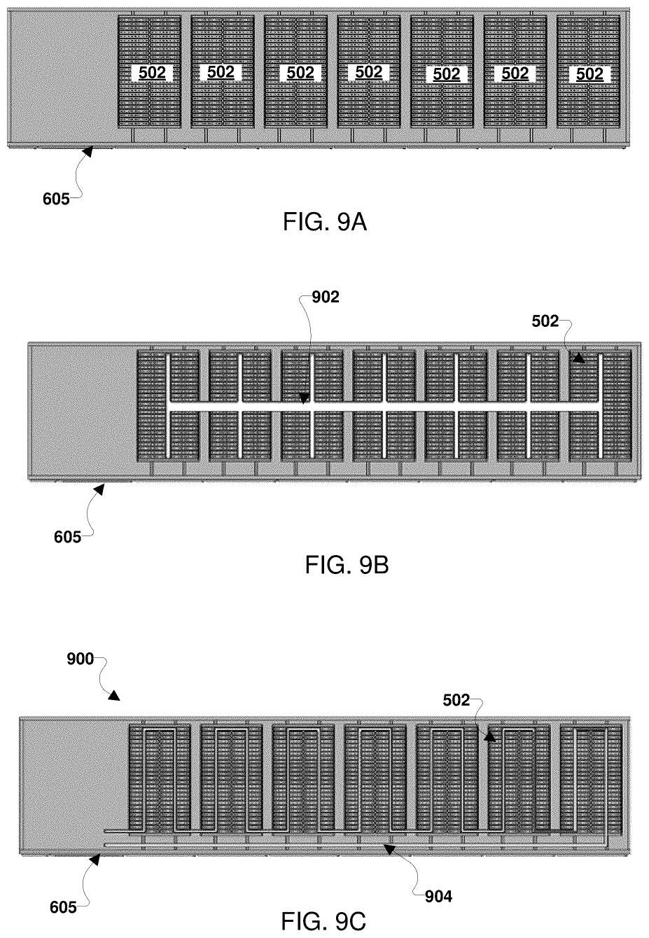

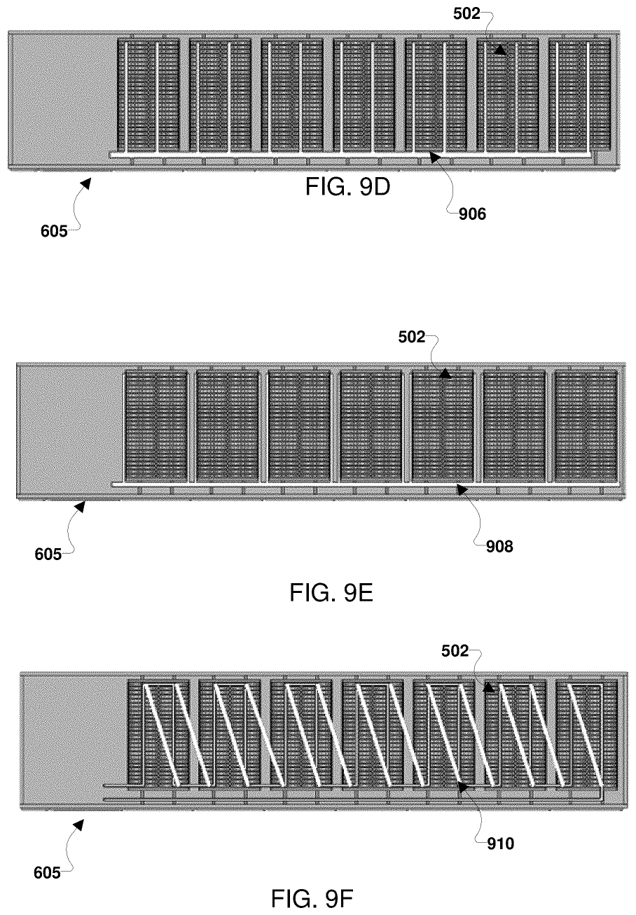

FIGS. 9A-9F are schematic representations of example layouts of a plurality of instances of the module 502 within the enclosure 605. In each of these layouts, the module connections may be at the doors of the module 502. Referring now to FIG. 9B, a thermal management ducting/plumbing system configuration 902 may be within the enclosure 605. Referring now to FIG. 9C, an electrical system connection 904 may be within the enclosure 605. Referring now to FIG. 9D, a GDE air system connection 906 may be inside the enclosure 605. Referring now to FIG. 9E, a water and/or electrolyte system connection 908 may be within the enclosure 605. Referring now to FIG. 9F, a second electrical system connection 910 may be within the enclosure 605. The second electrical system connection 910 may including blind mating at the back of each instance of the module 502 and front side connections.

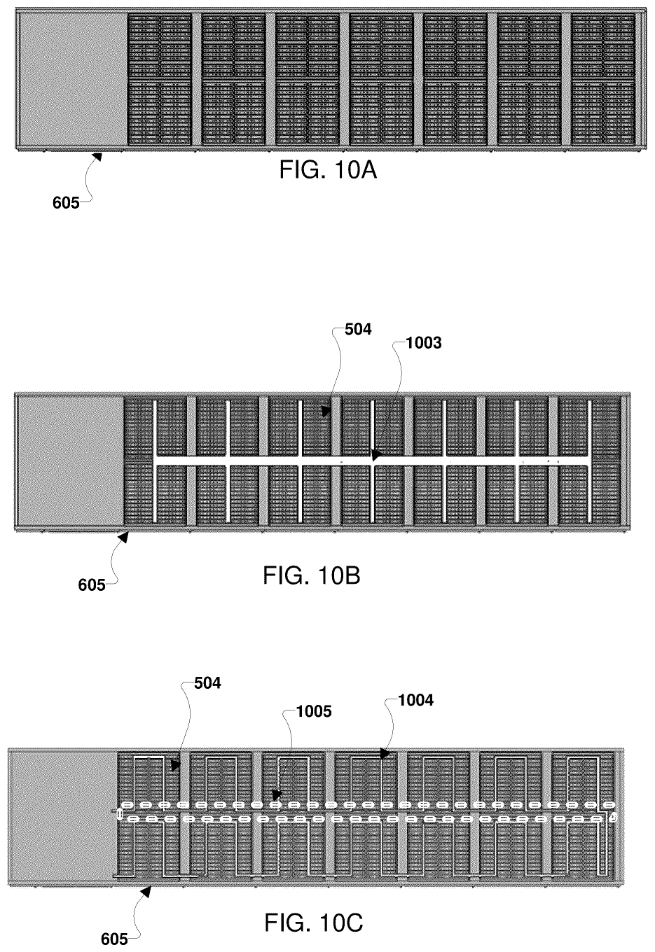

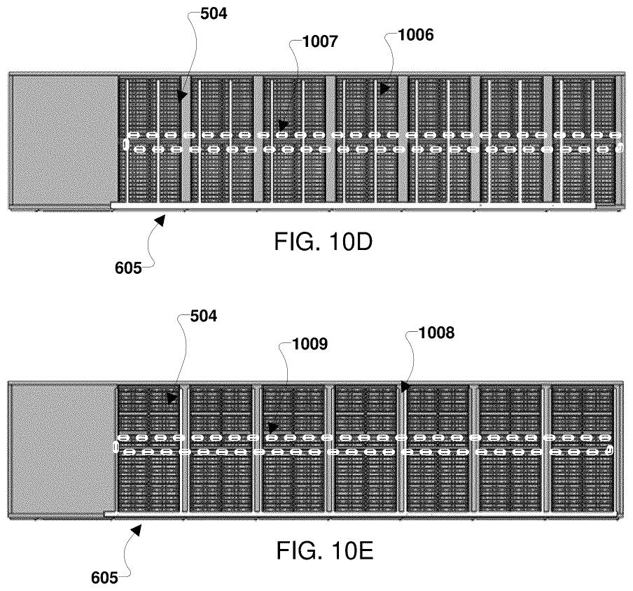

FIGS. 10A-10E are schematic representations of example layouts of a plurality of instances of the module 504 within the enclosure 605. In each of these layouts, two instances of the module 504 may be arranged front to back within a bay of the enclosure 605. In these layouts, space may be provided within the enclosure 605 to facilitate removal of an instance of the module 504. Further, or instead, in these layouts, electrode width of electrochemical cells in each instance of the module 504 may be independent of width of the enclosure 605. These layouts may include connection and/or disconnection of a back of one of the two instances of the module 504 in each bay. Still further, or instead, these layouts may facilitate some activities of personnel being performed in the enclosure 605.

Referring now to FIG. 10B, a thermal management ducting/plumbing system 1003 may be within the enclosure 605. Referring now to FIG. 10C, an electrical system 1004 and electrical connections 1005 may be within the enclosure 605 to facilitate installing and/or removing one or more instances of the module 504. Referring now to FIG. 10D, a GDE air system 1006 and air connections 1007 may be within the enclosure 605 to facilitate installing and/or removing one or more instances of the module 504. Referring now to FIG. 10E, a water and/or electrolyte system 1008 and fluid connections 1009 may be within the enclosure 605 to facilitate installing and/or removing one or more instances of the module 504.

While FIGS. 8A-10E represent various configurations for enclosures and modules within those enclosures, the layouts shown in FIGS. 8A-10E shall be understood to be examples according to various embodiments and are not intended to be limiting. Other layouts for enclosures and modules within those enclosures are additionally or alternatively possible.

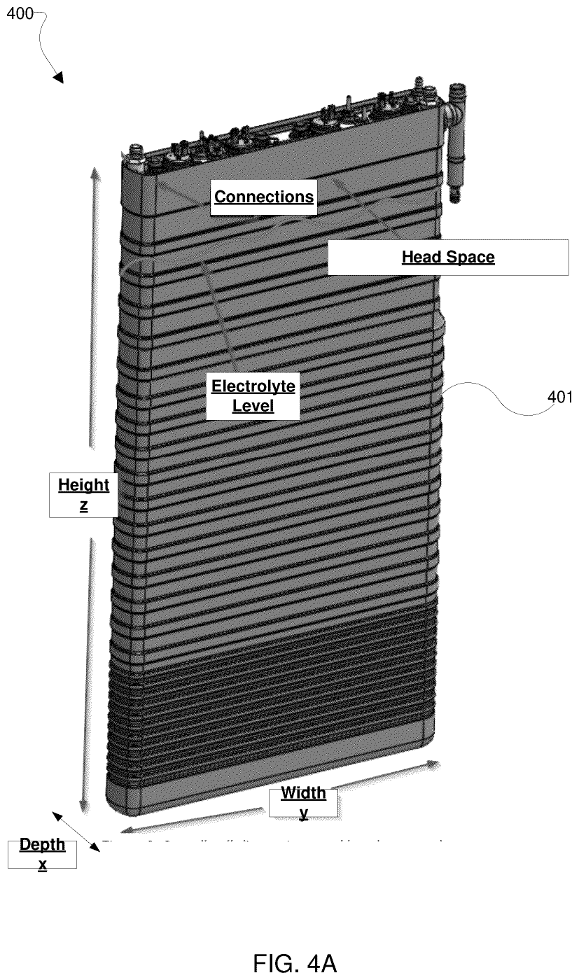

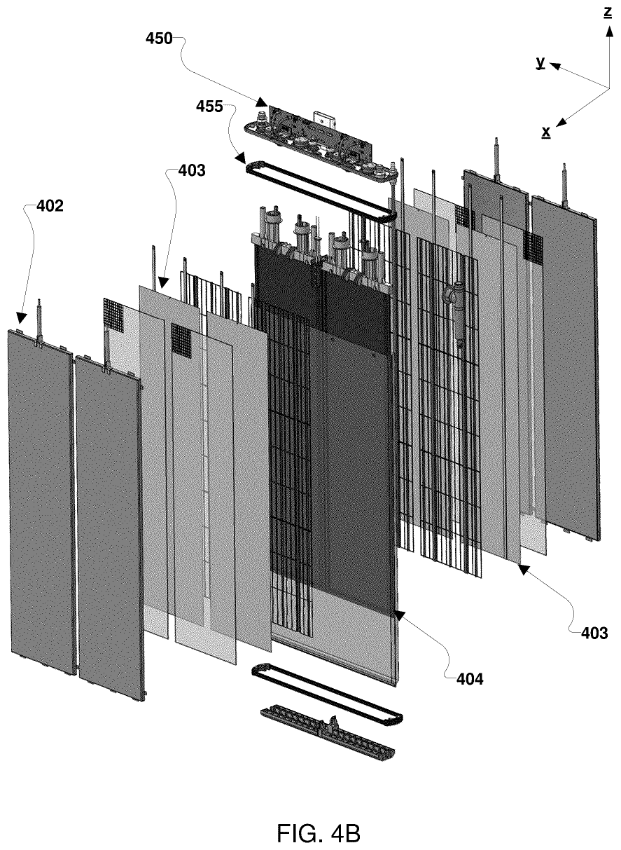

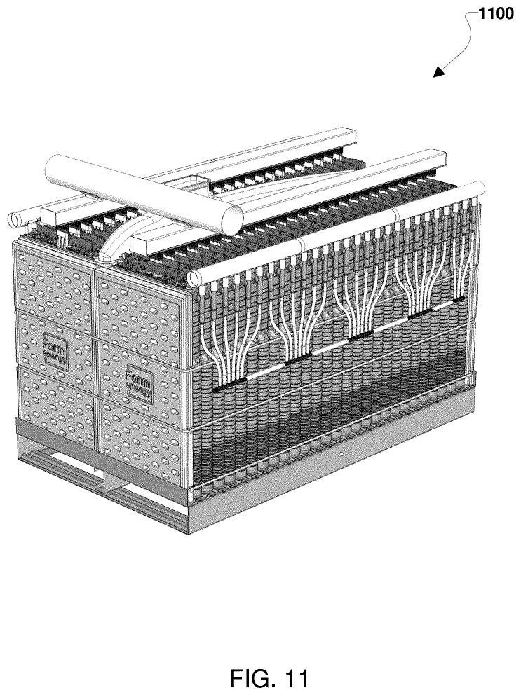

A module containing a plurality of electrochemical cells in a battery system is shown in FIG. 11. With reference to FIGS. 1-11, a module 1100 may include two rows of metal-air batteries (e.g., two rows of instances of the electrochemical cell 400 in FIGS. 4A-4B).

Within each cell, a cell-level control printed-circuit board (PCB) may make physical contact with all electrode tabs while also allowing access to the air ports and any electrical connections. The PCB may be oriented parallel to the lid of the electrochemical cell in some implementations. However, such orientation may make the PCB particularly vulnerable to damage from water, mist, or condensation, as liquids may pool on the top of the PCB causing shorts between components. Further, or instead, fluid leaking from the lid may eject directly onto components on the bottom of the PCB when the PCB is oriented parallel to the lid of the electrochemical cell. Therefore, in various embodiments, the electrochemical cell may include a PCB oriented perpendicular to the lid, rather than parallel to the lid.

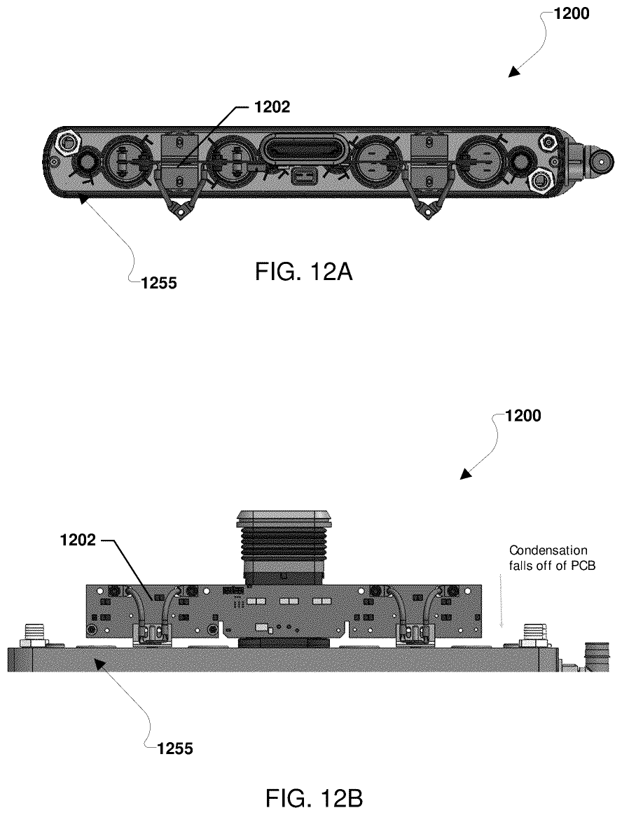

FIGS. 12A and 12B are top-down and side views, respectively, of a lid 1255 of an electrochemical cell 1200. The electrochemical cell 1200 may include a PCB 1202 vertically-oriented relative to the lid 1255. In some embodiments, such configuration may facilitate easy access to the air ports and/or to other electrical or plumbing connections on the lid 1255 of the electrochemical cell 1200. Additionally, or alternatively, any condensation or other liquid may drip off the PCB 1202 due to gravity.

Based on the distributed switching implemented, electrochemical cells of various embodiments may effectively have four cell positive terminals and four cell negative terminals. Therefore, electrochemical cells attached in series or parallel may have four connectors.

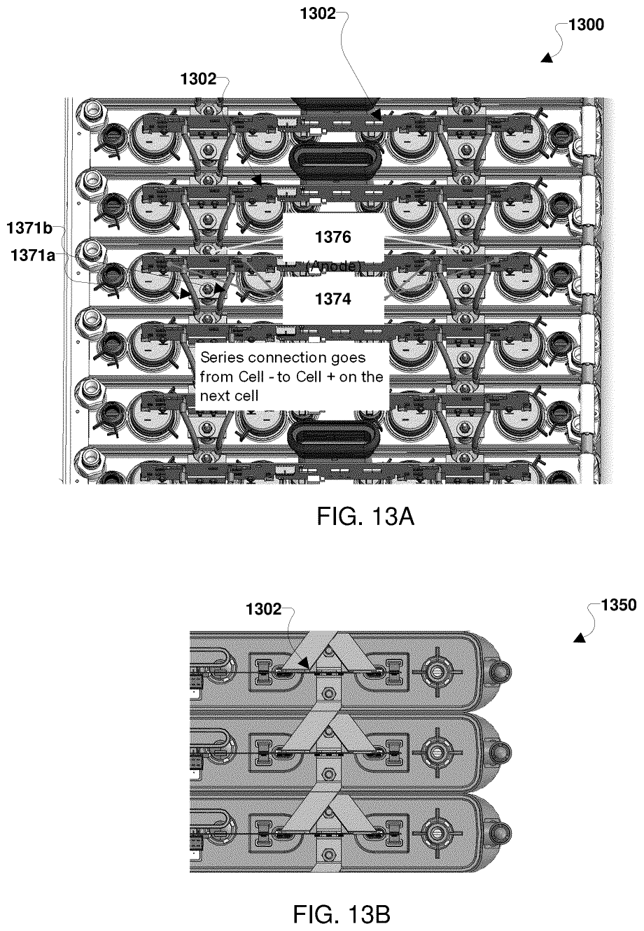

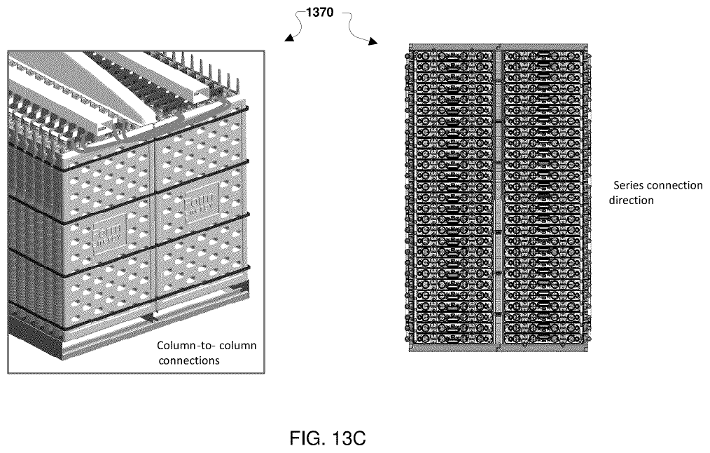

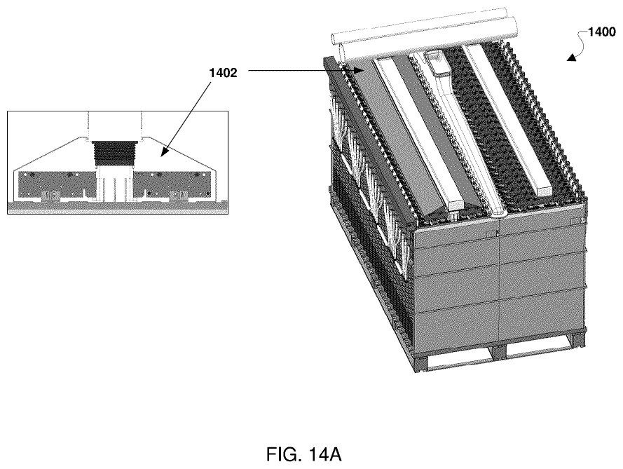

FIGS. 13A-13B are schematic representations of options for connecting stacked electrochemical cells. Because of the aspect ratio of the cells, a short bussing distance may be achieved by stacking the electrochemical cells, leading to improved system efficiency as compared to other arrangements of electrochemical cells.

FIG. 13A is a top-down view of a stack 1300 of electrochemical calls (e.g., the electrochemical cell 400 in FIGS. 4A-4B). In the stack 1300, four cables may connect each of the four cell positive terminals on the PCB 1202 of an electrochemical cell to the four cell negative terminals (anodes) on the next electrochemical cell in the stack.

FIG. 13B is a top-down view of a stack 1350 of electrochemical cells (e.g., the electrochemical cell 400 in FIGS. 4A-4B) in which busbars are used instead of cables, and provide a rigid electrical connection from the anodes on one cell to the controller on the next cell in the stack.

FIG. 13C is a schematic representation of electrical connections between groups of electrochemical cells in a module 1370 that includes a plurality of electrochemical cells arranged in at least two columns. At the module level, each electrochemical cell may be connected in series in a U shape as shown in the module 1370. Additionally, or alternatively, to connect one column to the next, two cables 1371a,b may connect cell positive terminals 1374 of one column to the cell negative terminals 1376 on the next column. Further, the module 1370 may be connected to neighboring modules (not shown in FIG. 13C).

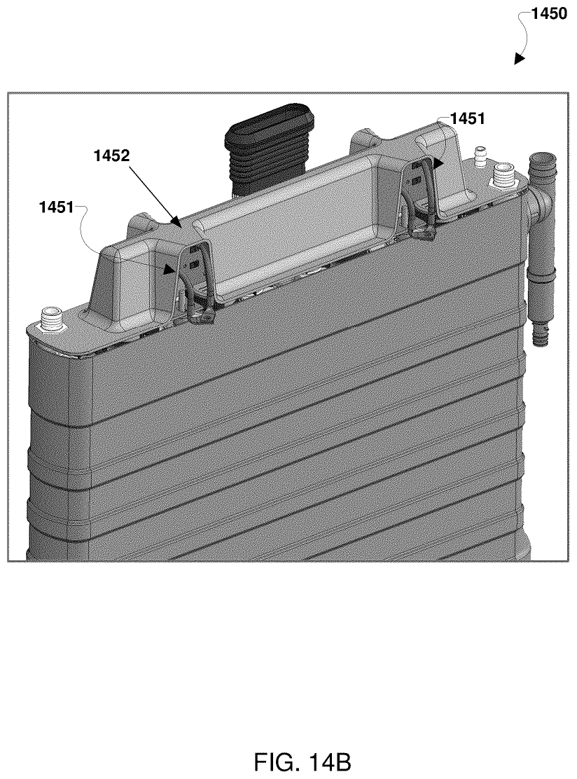

The PCB of an electrochemical cell may be vulnerable to both environmental effects and potential physical wear and tear. Additionally, or alternatively, if the sealing on the lid of the electrochemical cell fails, the PCB may be exposed to electrolyte mist. Therefore, a number of physical protections for PCBs may be employed in various embodiments, as shown in FIGS. 14A-14B. For example, the PCB may be conformal coated with a layer of acrylic to help isolate the PCB from potential chemical exposure. The conformal coat may be clear and may cover almost the entire PCB.

Referring now to FIG. 14A, a module 1400 may include a module-level cover 1402 to protect the respective PCBs of each of the electrochemical cells from impact or other physical damage. In some embodiments, the module-level cover 1402 may have a roof shape to facilitate natural convection to cool the PCBs. In some embodiments, the module-level cover 1402 may be made of metal instead of plastic.

Referring now to FIG. 14B, an electrochemical cell 1450 (e.g., the electrochemical cell 400 in FIGS. 4A and 4B) may include a protective cover 1452 that defines openings 1451 for the module-level electrical connections.

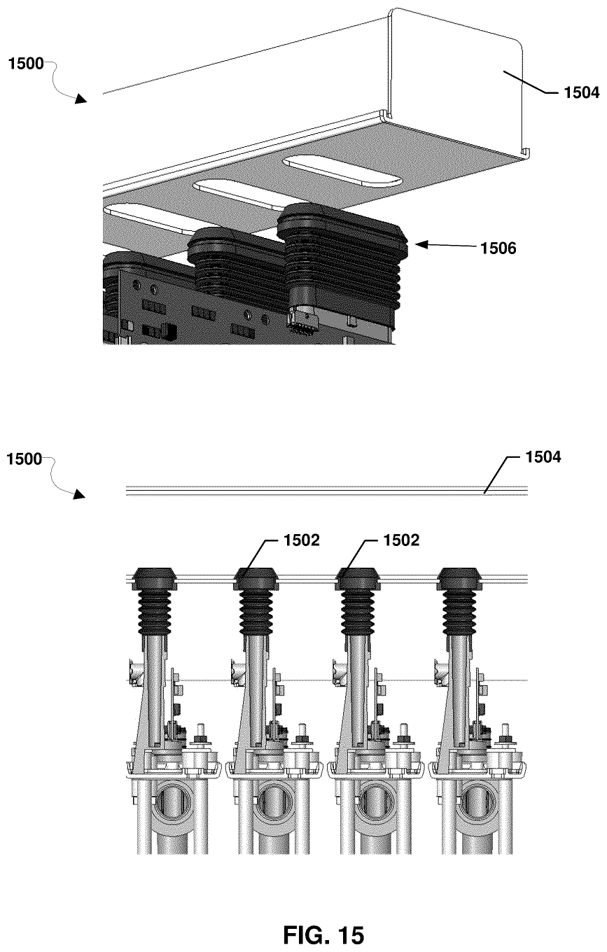

Referring now to FIG. 15, an enclosure 1500 of a module may include grommets 1502 (e.g., over-molded grommets) that may withstand the back pressure needed to supply enough air for the gas diffusion electrodes within a given module, while accounting for cell-to-cell misalignment across the length of the module. In some embodiments, each instance of the grommet 1502 may have a tapered top to facilitate insertion of the grommets 1502 into an air duct 1504 with defining prefabricated holes. Further, or instead, each instance of the grommets 1502 may include an interlock groove 1506 around the perimeter to serve as a mechanical interlock to the air duct 1504.

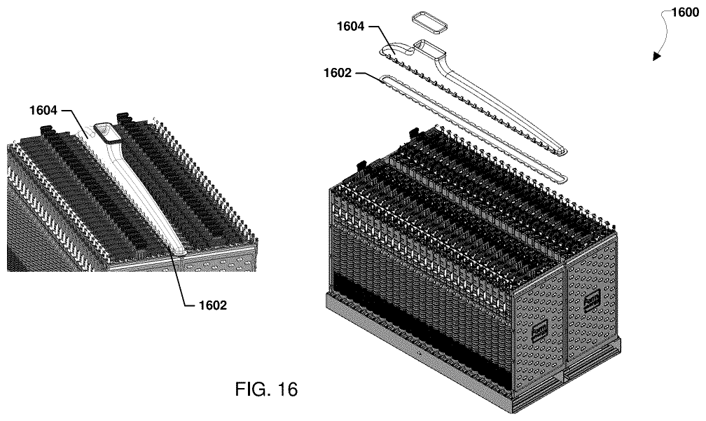

Referring now to FIG. 16, in some embodiments, enclosures may include low pressure compression gasketing between the module and a plenum. For example, a module 1600 may include a gasket 1602 that may form a seal between a plenum 1604 and the top portions of the electrochemical cells (e.g., the electrochemical cell 400 in FIGS. 4A and 4B) such that air may be concentrated between cooling channels of vessels of the electrochemical cells. The gasket 1602 may be low pressure compression gasketing, which may cause less reaction force on the plenum 1604, thus facilitating using only a fraction of the electrochemical cells of the module 1600 as mounting features to achieve an airtight seal. The top of the plenum 1604 may feature additional gasketing to facilitate linking the plenum 1604 in fluid communication with system-level ductwork. In various embodiments, the gasket 1602 may accommodate some variation in height of the electrochemical cells of the module 1600.

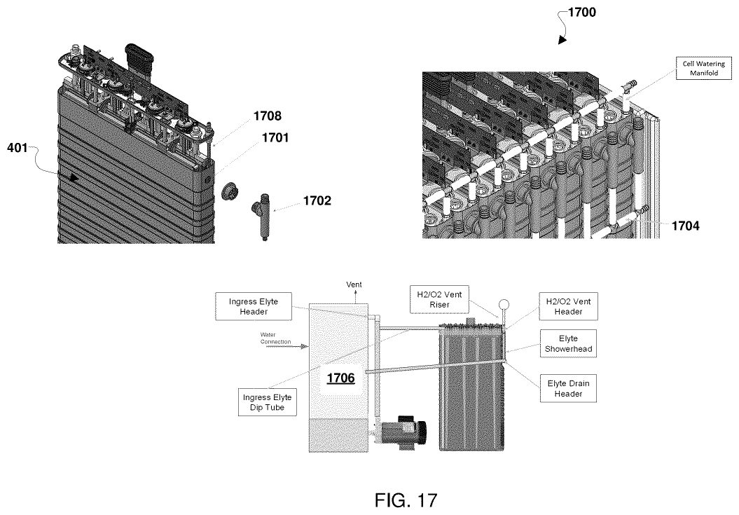

Referring now to FIG. 17, a system 1700 may manage electrolyte level for electrochemical cells. For example, in the system 1700, the vessel 401 for an electrochemical cell may include a port 1701 on the side such that overflow may move through a tee fitting 1702 during the charge cycle. As gas is generated in the electrochemical cell volume in a system 1700, the electrolyte may swell until the electrolyte spills out of the port 1701 and falls through an orifice plate in the tee fitting 1702 to enable Rayleigh instability. The orifice plate may break any continuous electrolyte stream to mitigate parasitic losses due to shunt current. In addition, the overflow through the port 1701 may reduce the likelihood that the electrochemical cells may be overfilled and this may be achieved without a float valve. The bottom of the tee fitting 1702 may be fluidically coupled to a manifold 1704 such that, after dripping out of the electrochemical cell, the manifold 1704 may plumb all overflow to a central reservoir 1706 used to refill electrolyte levels periodically through a straw 1708. Further, or instead, the straw 1708 may be used to drain the electrolyte from the electrochemical cell if needed.

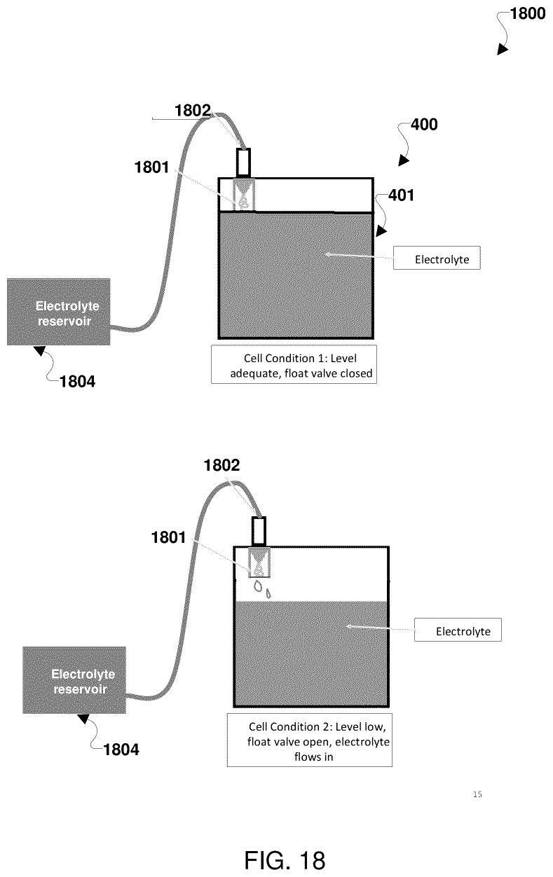

FIG. 18 is a schematic representation of a system for passive control of electrolyte volume level. For example, a system 1800 may include a float valve 1801 in fluid communication with the top of the vessel 401 of the electrochemical cell 400 to reduce the likelihood of overfilling the vessel 401. In this configuration, a fill port 1802 of each instance of the electrochemical cell 400 may be in fluid communication with a reservoir 1804, as may be useful for reducing or eliminate the need for manifolds to catch the overflow and plumb back to the reservoir.

During operation, heat may be generated as a result of the reactions within the electrochemical cells described herein. Keeping the temperature in these electrochemical cells within a given temperature range is important to performance of the electrochemical cell. However, since multiple electrochemical cells are stacked next to each other in a module, the electrochemical cells that are not on the end of the module generally have minimal exposure to surrounding air and, therefore, receive minimal cooling effects from the surrounding air. As a result, the electrochemical cells in the center of the module may exceed rated operating temperature during normal cycling.

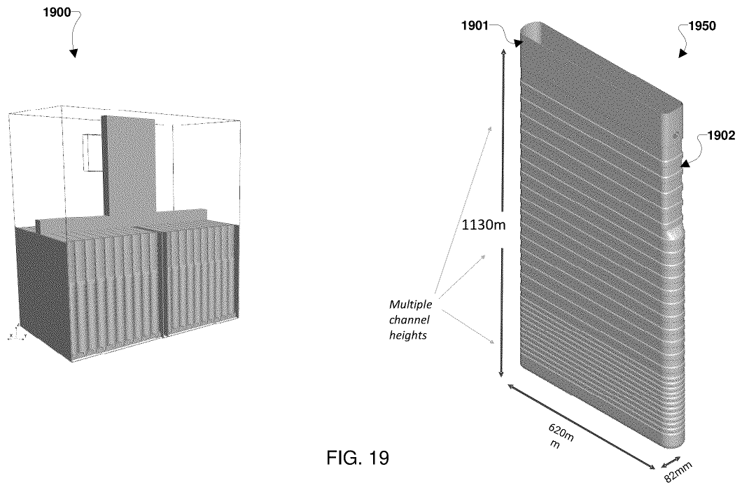

Referring now to FIG. 19, in some implementations, cooling channels and forced airflow between the electrochemical cells in a module may be used to control cell temperatures within an ideal operating window. For example, a module 1900 may include a plurality of electrochemical cells 1950 (e.g., a plurality of instances of the electrochemical cell 400 in FIGS. 4A and 4B) with a vessel 1901 of each instance of the plurality of electrochemical cells 1950 defining cooling channels 1902 having varying sizes along a length dimension of the vessel 1901. In particular, the cooling channels may be optimized to be smaller at the bottom of the vessel 1901 and larger at the top of the vessel 1901. While this may maximize strength along the bottom of the vessel 1901, this may additionally, or alternatively, facilitate increasing (e.g., maximizing) cooling area on the top of the vessel 1901, where the electrochemical cell 1950 tends to be warmer due to convection within the electrochemical cell 1950. For example, the heights of the cooling channels 1902 may range from 8 mm at the bottom of the vessel 1901 to 35 mm at the top of the vessel 1901.

To facilitate reducing cost, the vessels of electrochemical cells may be constructed using as little material as necessary. Thus, in some instances, the vessels may not be strong enough to hold back the full hydrostatic force when the vessel of the electrochemical cell is filled with the electrolyte. Additionally, or alternatively, because the vessels of electrochemical cells may be made with such little material, the vessels of electrochemical cells may be vulnerable to damage during transportation. Therefore, in some embodiments, additional rigidity and protection from shipping loads may be provided to electrochemical cells through various components in of the module that holds the electrochemical cells.

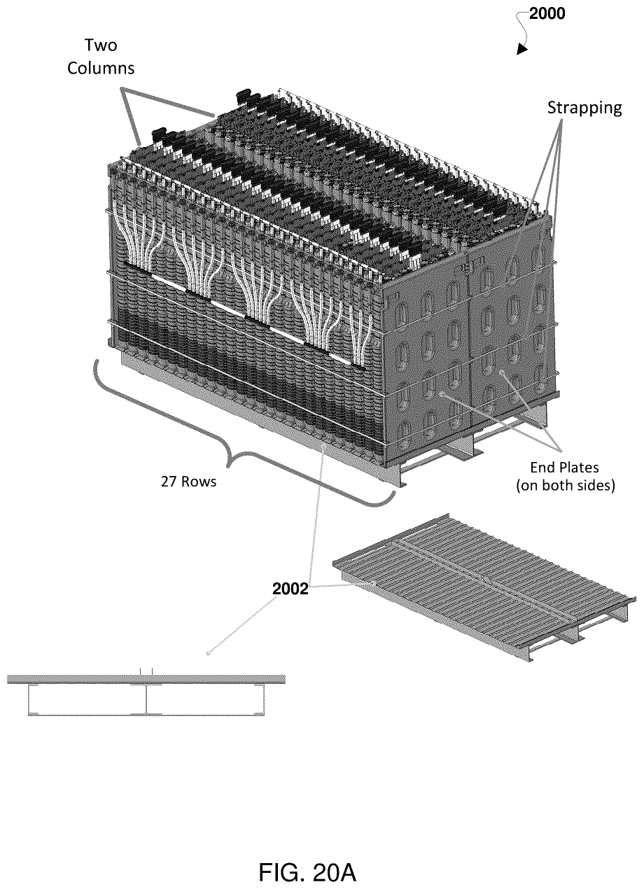

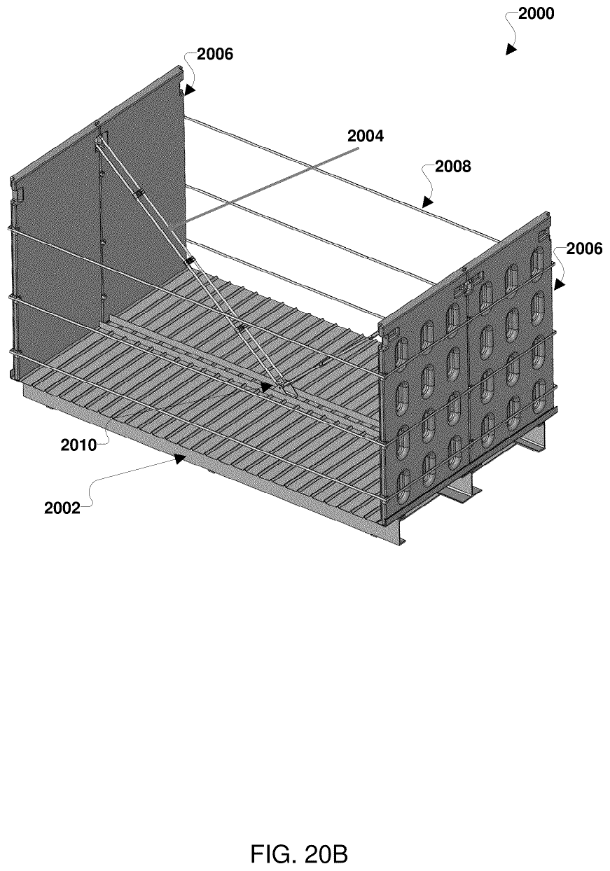

FIGS. 20A-20B are schematic representations of module structures that provide protection and support to electrochemical cells of the module. For example, a module 2000 may include a pallet 2002, tension members 2004, end plates 2006, and strapping 2008. In some embodiments, the pallet 2002 may hold electrochemical cells (e.g., the electrochemical cell 400 in FIGS. 4A and 4B) in two columns, with the electrochemical cells stacked tightly together. Each column may include 27 electrochemical cells (54 total cells in the module 2000. The two-column layout may facilitate simpler integration of the thermal management system, but the number of cells in a row may vary depending on space requirements. Further, or instead, the pallet 2002 may include features to locate the electrochemical cells and end plates 2006, and may be compatible with forklifts and pallet jacks.

The end plates 2006 may fit into the pallet 2002 on the start and end of a column of electrochemical cells in the module 2000. The end plates 2006 may be supported by the strapping 2008, and may withstand the hydrostatic pressure of the electrochemical cells in the module 2000. The strapping 2008 may hold the columns of the electrochemical cells and the end plates 2006 together. In some embodiments, the strapping 2008 may include steel banding and/or plastic.

While the strapping 2008 may keep the electrochemical cells parallel to one another, the strapping 2008 does not act to keep the electrochemical cells upright. However, the tension members 2004 may reduce the likelihood the electrochemical cells tilting. The tension members 2004 of module 2000 may be hollow steel tubes connecting the end plates 2006 to the center of the module 2000 through pin joints 2010 such that the tension members 2004 may act as force members in various embodiments. When a moment is applied to the end plates 2006 (e.g., when the module 2000 is lifted for transportation), the moment may be translated to either tension or compression of the tension members 2004, reducing the likelihood that the stack of electrochemical cells in the module 2000 may rotate. In various embodiments, the tension members 2004 may be only in the middle of the module and, thus, do not interfere with maintenance of the module 2000. That is, to replace an individual electrochemical cell, only the strapping 2008 may need to be removed.

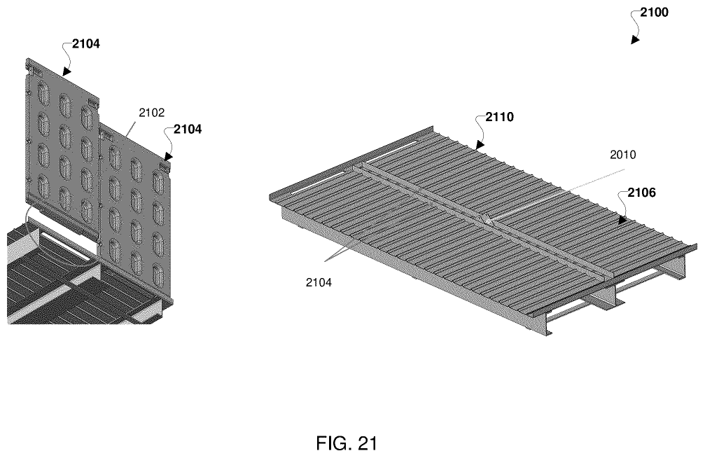

Referring now to FIG. 21, in various embodiments, a pallet of a module may have features for location and retention of the electrochemical cells and end plates, as shown in FIG. 21. For example, a pallet 2100 may define cutouts 2102 to facilitate positive location of end plates 2104, leaving only one degree of freedom. In addition, the cutouts 2102 may reduce the weight of the pallet 2100, as may be useful for saving shipping costs.

The decking 2106 of the pallet 2100 is the surface on which the electrochemical cells sit. The decking 2106 may be made of bent sheet metal that is epoxy coated to resist damage associated with electrolyte spilling during fill. Although the decking 2106 may be segmented in some embodiments, the decking 2106 may be a single continuous roll-formed sheet in other embodiments, as may be more cost effective at large scales. In various embodiments, the decking 2106 may locate neighboring electrochemical cells as required for the thermal management system. Additionally, or alternatively, tightly locating electrochemical cells together may cancel out of hydrostatic forces, so only the end plates 2104 are required to withstand the hydrostatic force.

In some embodiments, a bracket 2108 may be disposed in the middle of the pallet 2100 to facilitate mounting tension members (e.g., the tension members 2004 in FIG. 20B). In some embodiments, the pallet 2100 may include vertical rails 2110 that act as a hard stop for the electrochemical cells along the pallet 2100.

Various embodiments may include systems and methods for thermal management of modules including metal-air batteries, such as systems and methods for thermal management in modules 501, 502, 503, 504, 1100, 1370, 1400, 1600, 1900, 2000, etc. Various embodiments may facilitate cost-effective module-level thermal management architecture, along with acceptable control limits.

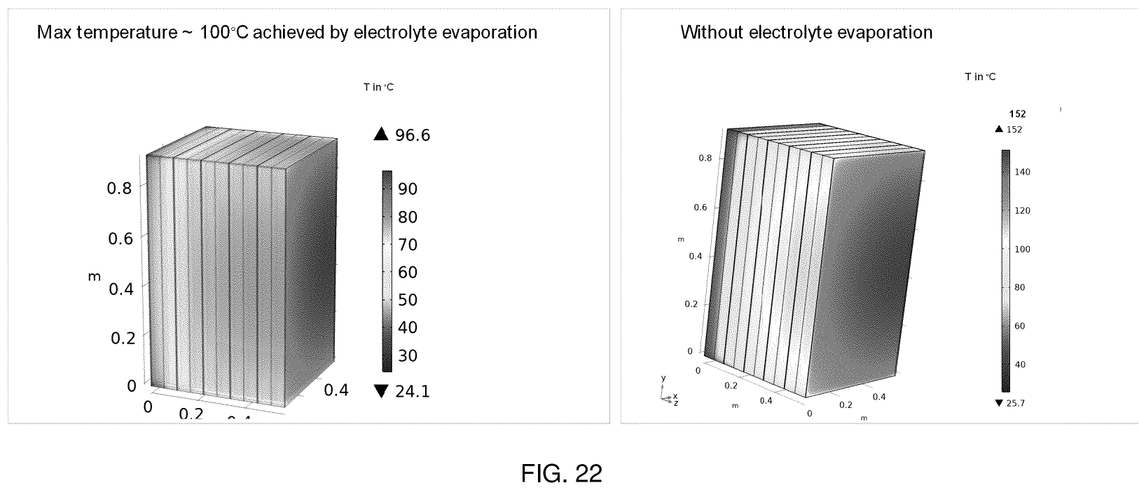

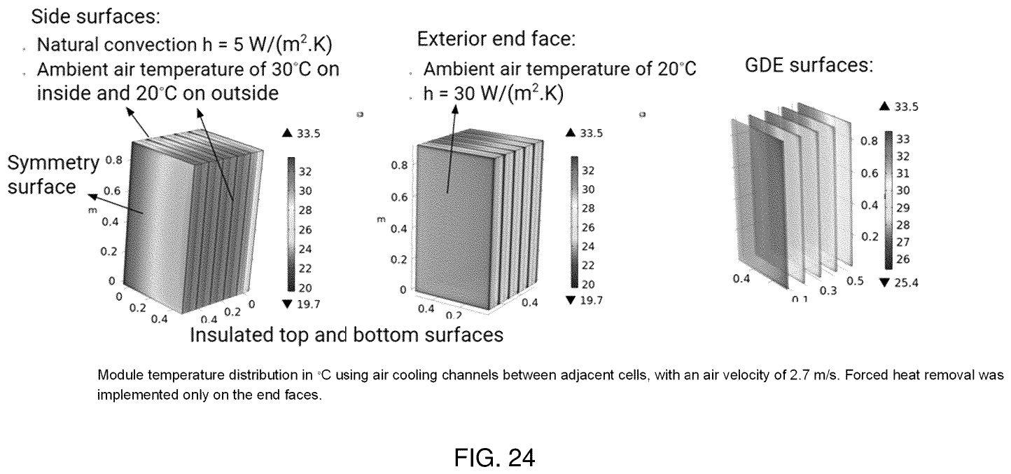

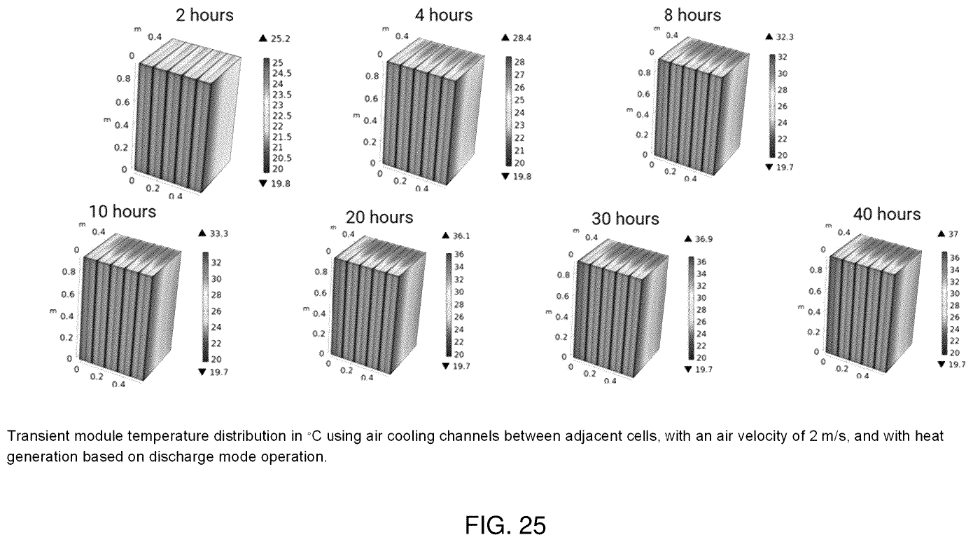

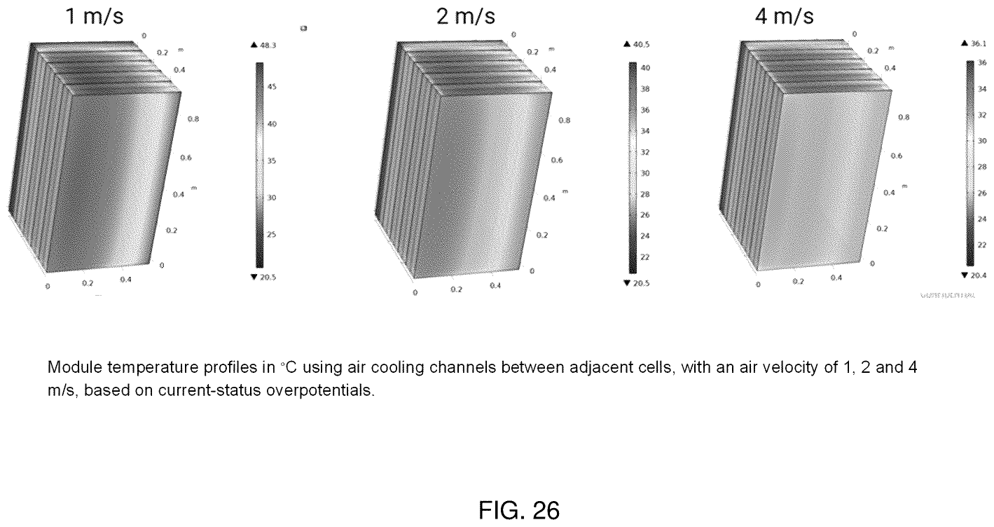

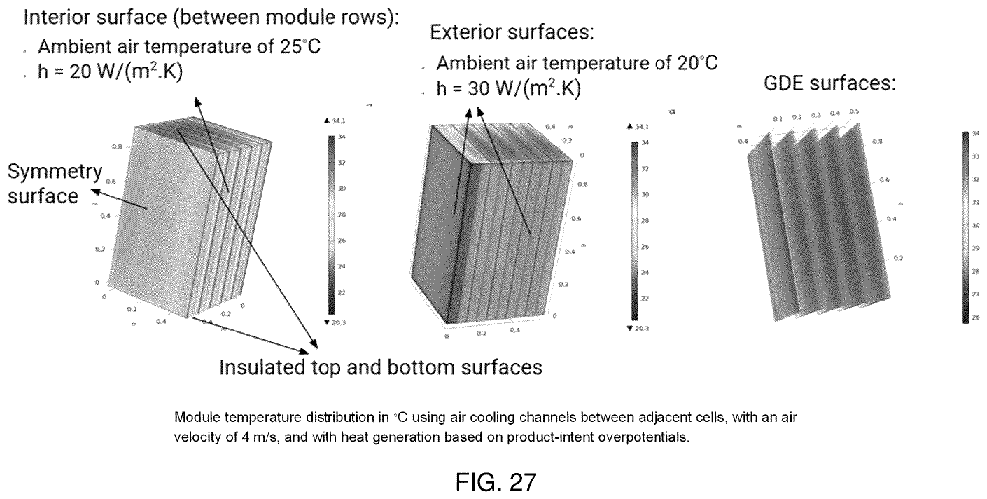

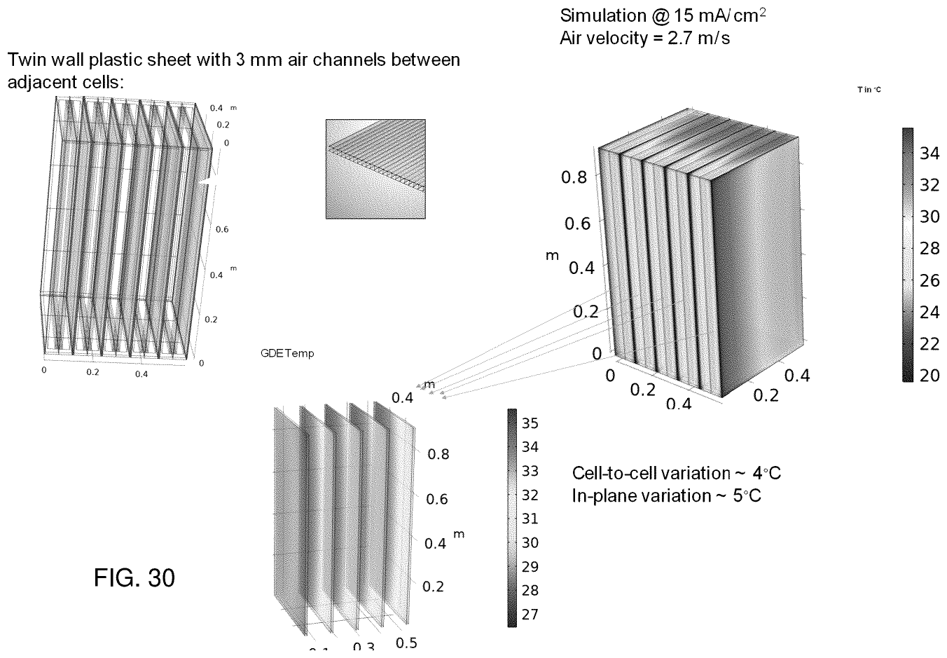

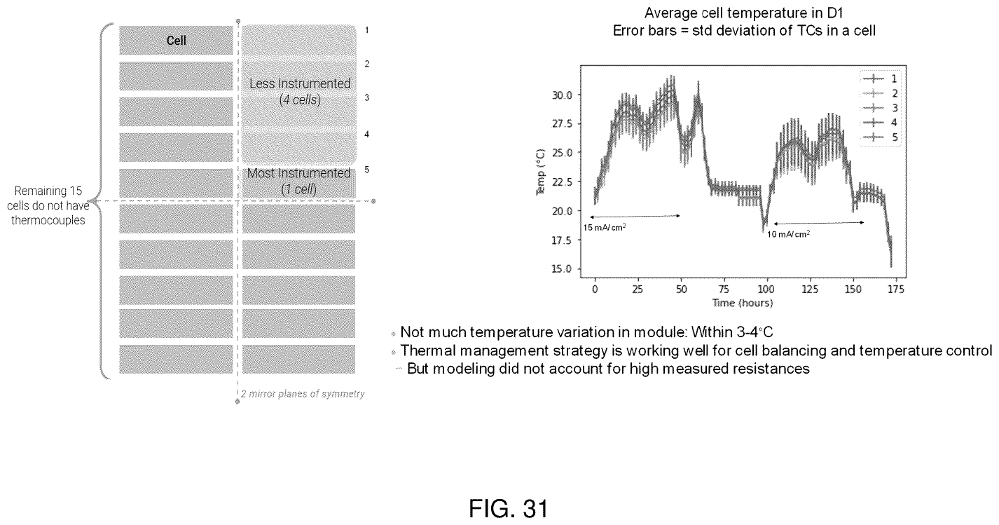

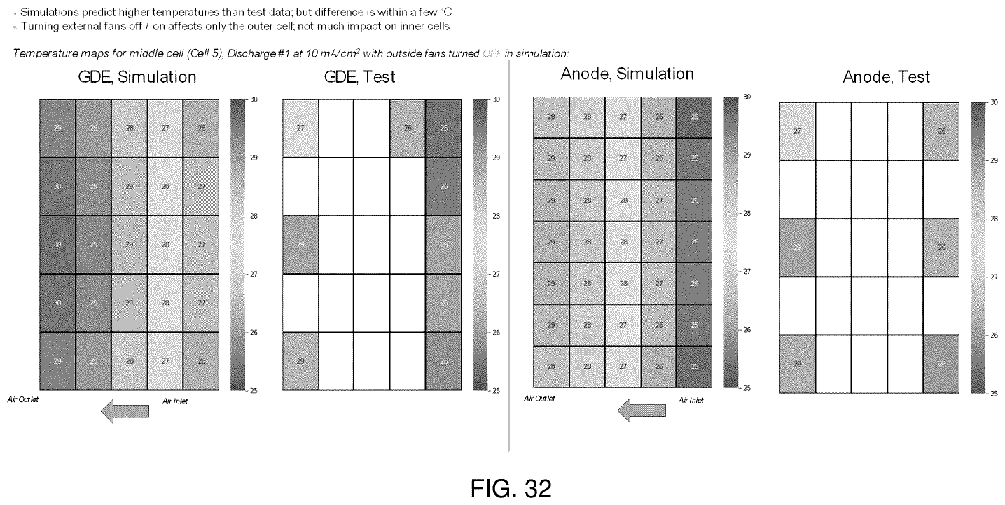

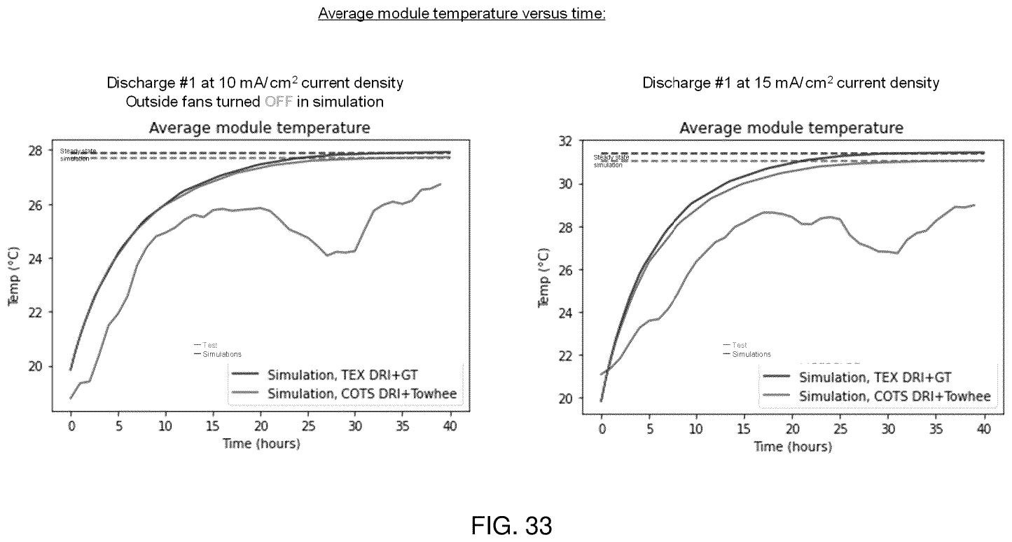

FIGS. 22-39 are computational fluid dynamic/finite element analysis simulations results associated with aspects of thermal management of modules of metal-air batteries in accordance with various embodiments. With reference to FIGS. 1-39, FIG. 22 is a graphical representation of simulation results of maximum temperatures achieved with electrolyte evaporation and without electrolyte evaporation. According to these simulations, the maximum temperature of the module with electrolyte evaporation may reach approximately 100° C., while the the maximum temperature of the module without electrolyte evaporation may reach about 150° C. The electrolyte may boil at approximately 112° C. The plastic of the module may transition to a rubbery state at approximately 108° C. with plastic softening and/or creep at greater than about 85° C. Performance degradation in a module may occur at approximately greater than about 60° C. Thus, thermal management to control maximum temperature of a module is a challenge in modules including large-format metal-air electrochemical cells.

One method for thermal management in accordance with various embodiments may include forced air convection between adjacent vessels of electrochemical cells (e.g., adjacent instances of the vessel 401 in FIG. 4A) in a module (e.g., module 501, 502, 503, 504, 1100, 1370, 1400, 1600, 1900, 2000). The cooling design may be based on the addition of air channels between adjacent vessels of electrochemical cells.

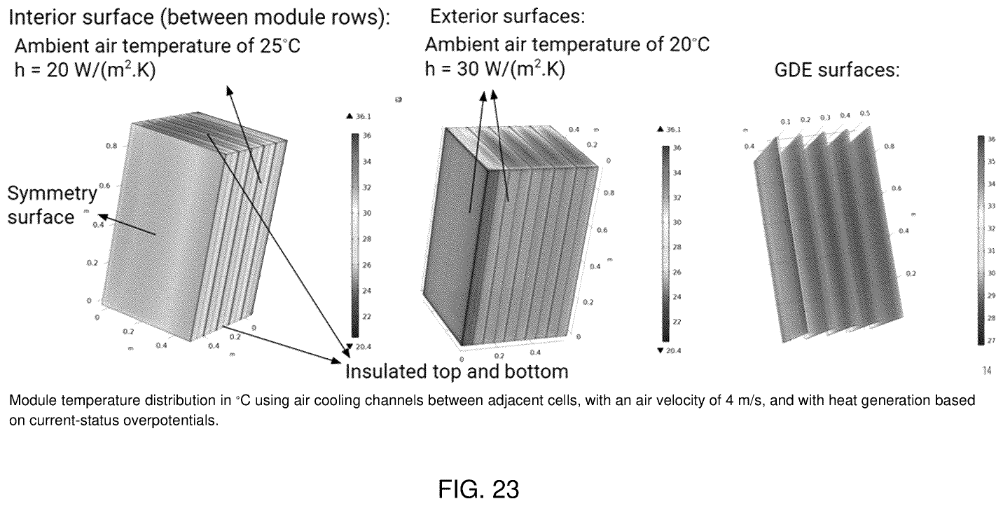

FIGS. 23 through 33 are graphical representations of aspects a computational fluid dynamic/finite element analysis simulation of a module in which air channels are present between adjacent instances of vessels of electrochemical cells. In the simulation, the module was modeled as having 3 mm wide air channels, with ½ mm thick acrylic sheets forming the walls on either side of the air channels between adjacent vessels of electrochemical cells. The air flow was modeled as moving in between the rows the electrochemical cells of the module to the exterior of the module (this was inverted in later simulations). In addition, the use of fans or blowers to blow air on the surfaces between the module rows and on the exterior surfaces was assumed for these simulations. One quadrant of the module was simulated, with the temperature in between the module rows assumed to be 5° C. higher than the ambient temperature of 20° C. to account for the confinement effect between the rows of the electrochemical cells of the module. The inlet air temperature in the air channels was assumed to be equal to the temperature between the rows of the electrochemical cells of the module, corresponding to the flow direction. The heat transfer coefficient was assumed to be 20 W/(m²K) for the surfaces facing the interior between the rows of the electrochemical cells of the module, to account for the confinement, and 30 W/(m²K) for the exterior surfaces. The heat transfer coefficient of 50 W/(m²K) for the exterior surfaces was also implemented, but the results were not found to be significantly different.

The selection of heat transfer coefficients for cooling with fans or blowers is described here. Air velocities of 4 m/s, 2 m/2, and 1 m/s were implemented in simulations. The Reynolds numbers associated with these velocities lie in the laminar regime. In the simulations, this cooling strategy both reduced the maximum module temperature, and limited the cell-to-cell temperature variation to about 16° C. Various embodiments may include blowing air through the air channels in the direction from the module exterior to the center between the rows of the electrochemical cells of the module. This allows the outlet air to be sucked out from in between the rows of the electrochemical cells of the modules. These simulation results suggest the target air velocity may be 2.7 m/s.

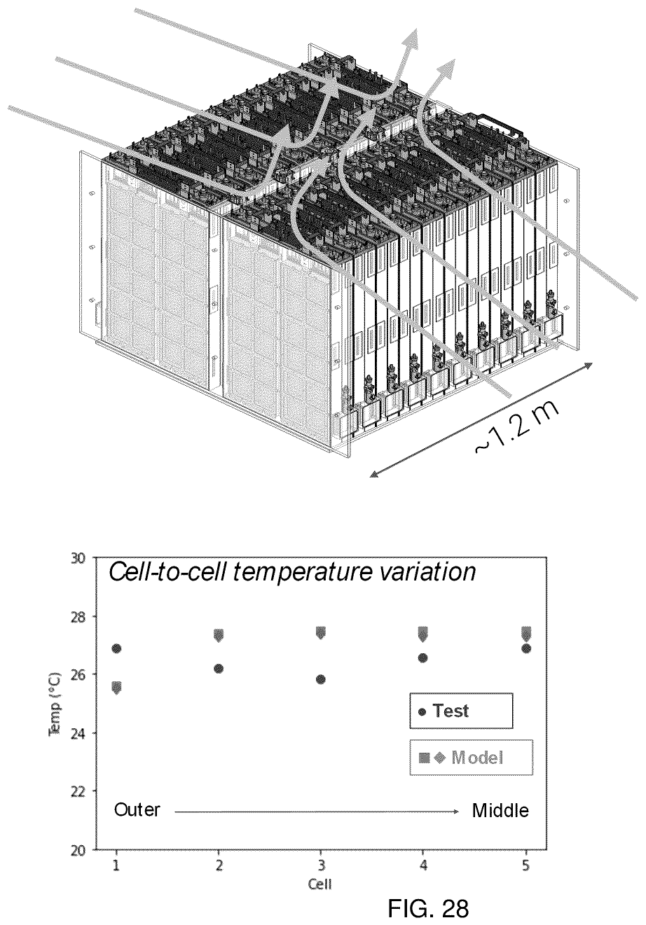

FIG. 28 is a comparison of test results and computational fluid dynamic/finite element analysis simulations for an air flow configuration in which forced air enters from the exterior sides of the module and through the center of the module to provide forced air cooling between electrochemical cells of the module. In the tests performed on this design, 183 thermocouples were embedded to spatially map the internal temperatures of the module. The maximum internal temperature of this forced air cooling design was measured to be less than 15° C. rise-over-ambient. The simulation model accuracy was validated with the simulation model of the module being within 5° Celsius of the experimental test results. The temperature uniformity was excellent, with the maximum temperature variation across the entire module measured to be only 3° C. The graph in FIG. 28 shows the cell-to-cell temperature variation measured on the test module and simulated using a thermal model of the module.

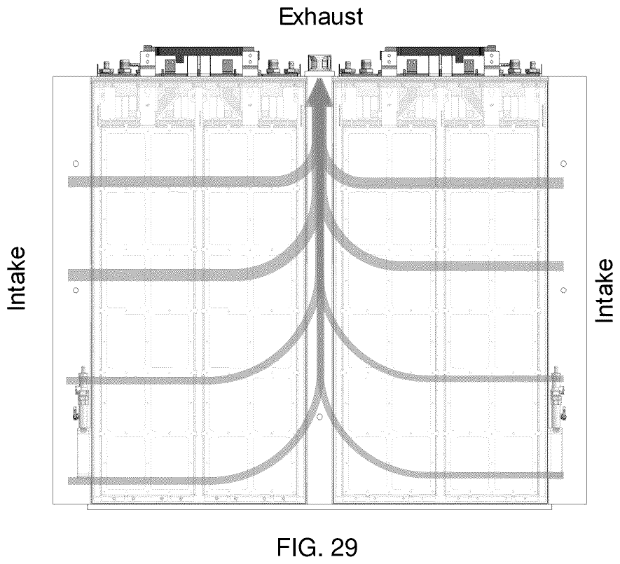

FIG. 29 is a schematic representation in forced convection cooling in which direct air feeds to a module from outdoor ambient air. Air flow channels are provided between each electrochemical cell to improve convective heat transfer and to improve inter-cell temperature homogeneity. As compared to exhausting elsewhere along the module, the center exhaust with the module subdivided along the middle of the module may improve intra-cell temperature uniformity, reduce blower pressure requirements, and/or reduce air flow requirements (e.g., lower auxiliary system energy requirements).

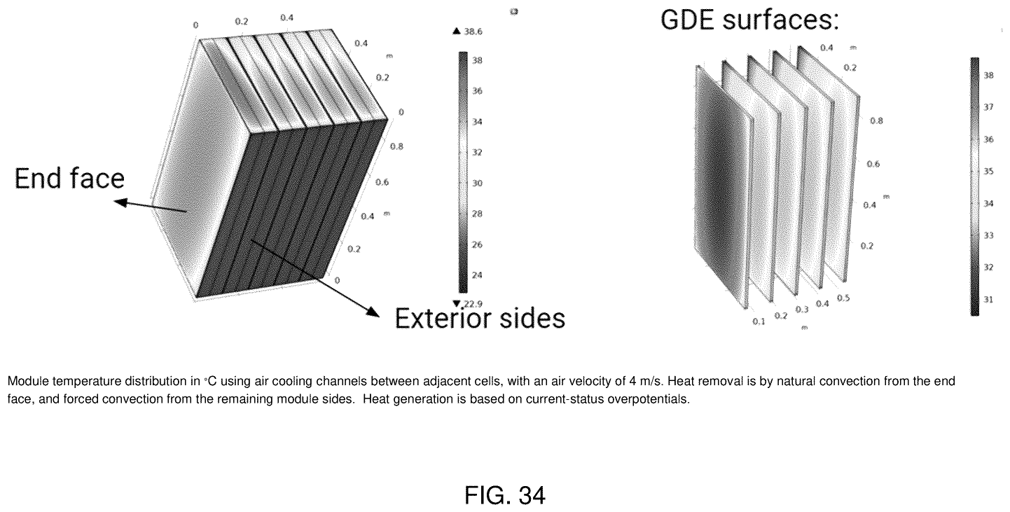

Other thermal management approaches in accordance with various embodiments may include air cooling using fans implemented on the exterior sides but not the end faces of a module. This strategy was motivated by the simulations showing lower temperature at the electrochemical cell at the end of the module, compared to the other cells. These simulations were based on using the natural convection heat transfer coefficient of 5 W/(m²K) on the end surface, while using forced convection heat transfer on the remaining surfaces as before and the results are shown in FIG. 34.

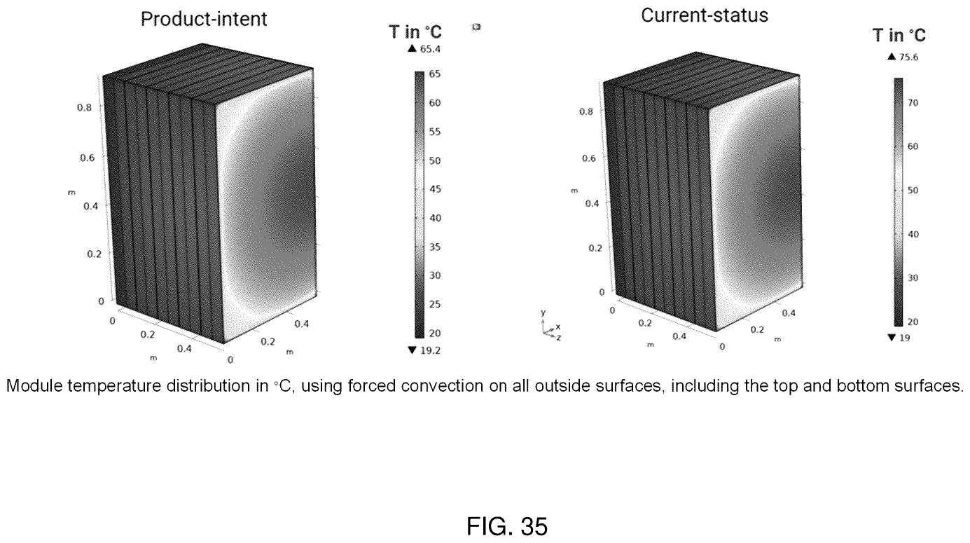

Other thermal management approaches in accordance with various embodiments may include exterior forced air convection in which forced air convection on all exterior surfaces, including the top and bottom surfaces, is provided. The simulation of this arrangement was performed with an external forced convection boundary condition at a heat transfer coefficient of 50 W/(m²K), and an ambient temperature of 20° C. Simulating the top and bottom surfaces as insulated led to higher temperatures in the simulation, as shown in FIG. 35.

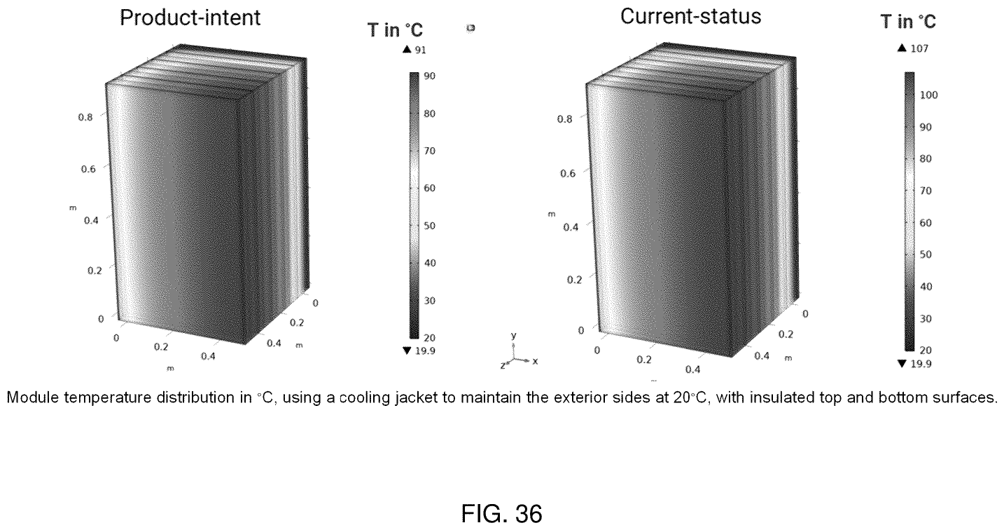

Other thermal management approaches in accordance with various embodiments may include using an exterior liquid or air cooling jacket. A cooling jacket on external side surfaces was simulated, using a constant temperature boundary condition on the side surfaces at a temperature of 20° C., with top and bottom surfaces simulated as insulated. The results of this simulation are shown in FIG. 36.

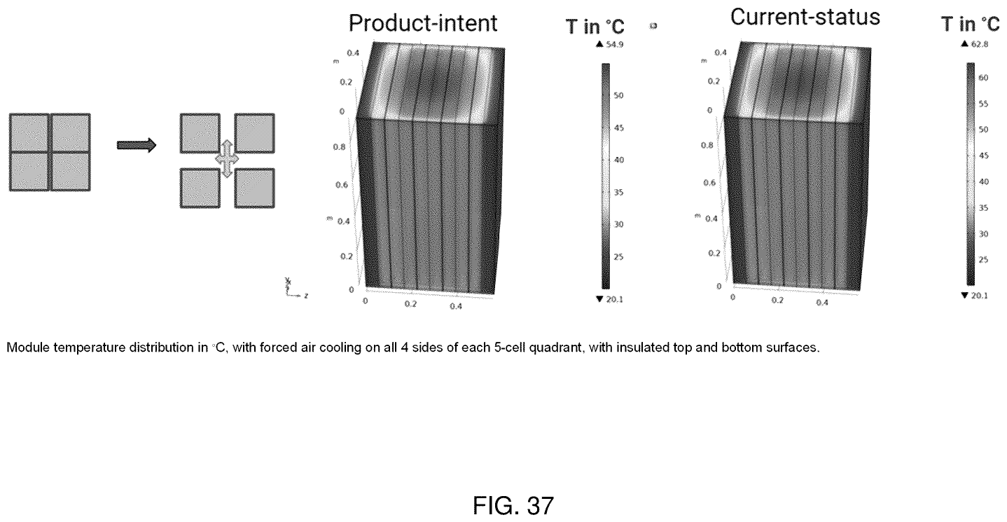

Other thermal management approaches in accordance with various embodiments may include a module with forced air cooling channels around blocks of cells as shown in FIG. 37. This arrangement was simulated with forced air convection on all 4 sides of each 5-cell quadrant, with an optimistic forced convection heat transfer coefficient of 50 W/(m²K) and an ambient temperature of 20° C. The module top and bottom were simulated as insulated. This reduced the simulated maximum temperature at the center of the module, as shown in FIG. 37.

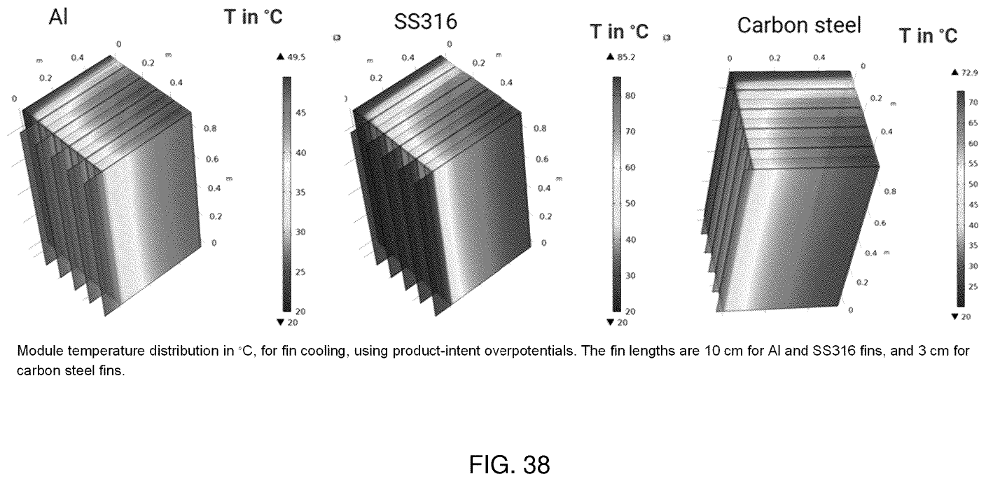

Other thermal management approaches in accordance with various embodiments may include providing metal cooling fins between cells. Fin cooling was simulated, using fins of thickness 3 mm between adjacent cells, and external fin length outside the module of up to 20 cm fin length. The simulation results revealed that only about 3 cm of fin length is utilized, and heat transfer is limited by heat conduction in the module as shown in FIG. 38. The following materials may be used for fins and were simulated: stainless steel (SS316), aluminum (anodized to reduce corrosion from electrolyte contact), and carbon steel.

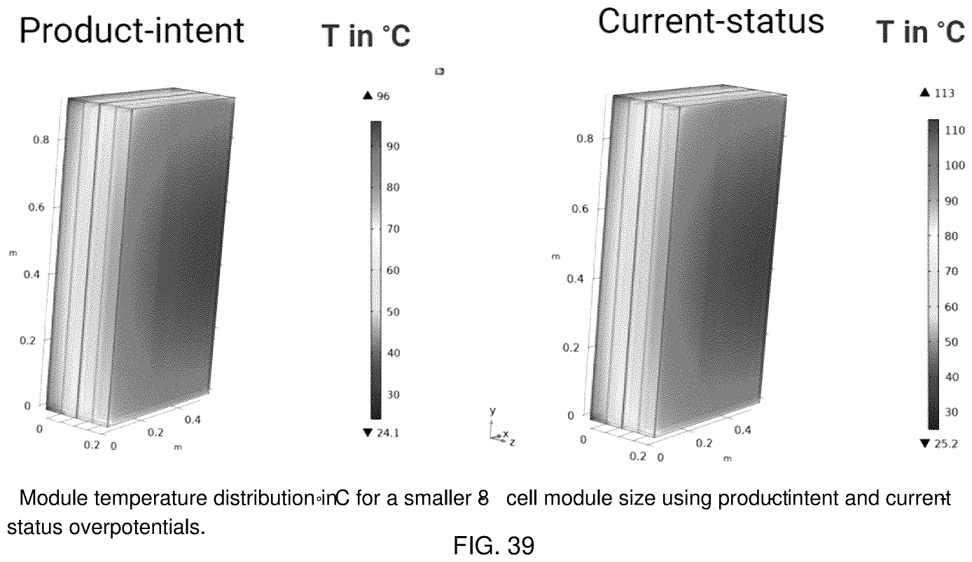

Other thermal management approaches in accordance with various embodiments may include using smaller string lengths of cells in modules. Thermal effects of smaller string length on module temperatures were considered and simulated as shown in FIG. 39. The use of fewer cells in the module was analyzed as a way to reduce the heat buildup at the module center, without applying forced cooling. FIG. 39 shows the simulated temperature profile for a quadrant of an 8-cell module (comprising 2 rows of 4 cells each). In this simulation, heat was removed by natural convection to air alone on the external surfaces, at a heat transfer coefficient of 5 W/(m²K) and an ambient temperature of 220° C.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular. Herein, “about” may refer to a range of +/−5%.

Further, any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A power storage system comprising:
an enclosure; and
one or more modules disposed in the enclosure, each of the one or more modules including a plurality of electrochemical cells electrically coupled to one another, each one of the plurality of electrochemical cells including an oxygen evolution electrode (OEE), an anode, a gas diffusion electrode (GDE), an electrolyte, and a vessel and, within the vessel, the OEE, the anode, and the GDE at least partially immersed in the electrolyte.

2. The power storage system of claim 1, wherein each of the plurality of electrochemical cells includes a printed circuit board (PCB) and a lid, the lid is supported on the vessel, and the PCB is oriented perpendicular to the lid.

3. The power storage system of claim 1, wherein each of the one or more modules includes cell-to-cell busing including cables and/or busbars.

4. The power storage system of claim 1, wherein the plurality of electrochemical cells are arranged in at least two columns, each one of the plurality of electrochemical cells includes a cell positive terminal and a cell negative terminal, and cell positive terminals of the plurality of electrochemical cells in a first column are electrically connected to the cell negative terminals of the plurality of electrochemical cells in a second column using two cables.

5. The power storage system of claim 1, wherein each one of the plurality of electrochemical cells includes a printed circuit board (PCB), and each of the one or more modules further includes a cover positionable over the PCBs of the plurality of electrochemical cells in a respective one of the one or more modules.

6. The power storage system claim 1, wherein each one of the plurality of electrochemical cells includes a printed circuit board (PCB), a lid, and a protective cover, the lid is supported on the vessel, the PCB is supported on the lid, and the protective cover is positionable on the lid to cover the PCB.

7. The power storage system of claim 1, wherein each one of the plurality of electrochemical cells further includes grommets flexible for sealing the given electrochemical cell in fluid communication with an air supply duct.

8. The power storage system of claim 1, further comprising a plenum and a gasket, wherein the gasket is disposed between the plenum and top portions of at least some of the plurality of electrochemical cells.

9. The power storage system of claim 1, wherein the vessel of each one of the plurality of electrochemical cells includes a side port through which the electrolyte of the given electrochemical cell may overflow from the vessel during a charge cycle.

10. The power storage system of claim 1, wherein each one of the plurality of electrochemical cells includes a float valve actuatable to prevent overfilling the vessel with the electrolyte.

11. The power storage system of claim 1, wherein, in the module, the plurality of electrochemical cells collectively define cooling channels therebetween and through which forced air flow is movable between the plurality of electrochemical cells.

12. The power storage system of any of claim 1, wherein each of the one or more modules further includes a pallet, end plate, and strapping, the plurality of electrochemical cells are supportable on the pallet in two columns, the end plates are releasably securable to the pallet at front and back ends of each of the two columns, and the strapping hold the two columns of the plurality of electrochemical cells and the end plates together on the pallet.

13. The power storage system of claim 12, wherein the pallet defines cutouts, and the end plates are releasably securable to the pallet via the cutouts.

14. The power storage system of claim 12, wherein each of the one or more modules further includes tension members, each tension member connected to one of the end plates to a center of the pallet via pin joints.

15. The power storage system of claim 14, wherein each of the one or more modules further includes a bracket, and the tension members are mechanically couplable to the bracket via the pin joints.

16. The power storage system of claim 1, wherein each of the one or more modules supports the plurality of electrochemical cells such that forced air is movable between adjacent electrochemical cells.

17. The power storage system of claim 1, wherein each of the one or more modules supports the plurality of electrochemical cells such that forced air is movable over portions of the plurality of electrochemical cells towards exterior sides of the given module.

18. The power storage system of claim 1, wherein the plurality of electrochemical cells are formed in blocks within each of the one or more modules and forced air is movable between the blocks within the one or more modules.

19. The power storage system of claim 1, wherein the one or more modules includes a plurality of modules, each one of the plurality of modules supports the plurality of electrochemical cells in two columns, each one of the plurality of modules are spaced relative to one another within the enclosure such that forced air is movable over instances of the electrochemical cells at ends of each of the two columns of each one of the plurality of modules.

20. The power storage system of claim 1, wherein the plurality of electrochemical cells include iron-air type battery cells, zinc-air type battery cells, and/or lithium-air battery cells.
